(19) United States
(12) Patent Application Publication
(10) Pub. No.: US 2021/0357848 A1
(43) Pub. Date: Nov. 18, 2021

(54) Configurable and Interchangeable System for Storing and Viewing Objects

(71) Applicant: Katheran Barton, Brentwood, TN (US)

(72) Inventor: Katheran Barton, Brentwood, TN (US)

(21) Appl. No.: 16/927,110

(22) Filed: Jul. 13, 2020

Related U.S. Application Data
(63) Continuation of application No. 29/734,530, filed on May 13, 2020.

(51) Int. Cl. G06Q 10/08; A45C 11/16; G07C 9/00

(52) U.S. Cl. CPC G06Q 10/087; H04L 67/12; G07C 9/00182; A45C 11/16

(57) ABSTRACT

A “Visible Storage and Object Retrieval” (ViSOR) system provides a modular system for concurrently organizing, storing, protecting and viewing objects stored within various containers (referred to herein as “windowed storage devices”) having a fully or partially transparent or translucent window that enables a user to view container contents without needing to open that container. These windowed storage devices are further configured to interface with a wide variety of interchangeable storage devices and systems while preventing tangling, knotting, destruction, breakage, interweaving, etc., of objects contained therein. More specifically, each windowed storage device is removably couplable to a plurality of storage modalities, either directly, or via an intermediary connector that itself is configured to be removably coupled to any of the storage modalities. These intermediary connectors enable windowed storage devices to be transferred between a variety of storage modalities. In further implementations, the ViSOR system includes a computer-based monitoring and access system.

### CROSS-REFERENCE TO RELATED APPLICATIONS

This application claims the benefit of a previously filed U.S. Design patent application, Ser. No. 29/734,530 filed on May 13, 2020, by Katheran Barton, and entitled “Object Pouch with Transparent Front”, which is incorporated by reference herein in its entirety.

### BACKGROUND

Storage systems and devices often include various mechanism for securing, holding, or otherwise storing one or more objects of various sizes and types within containers such as boxes, bags, pouches, etc. In addition, various inventory control systems enable tracking of both overall inventory and storage locations for individual objects within such storage systems.

### SUMMARY

The following Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. Further, while certain disadvantages of other technologies may be discussed herein, the claimed subject matter is not intended to be limited to implementations that may solve or address any or all of the disadvantages of those other technologies. The sole purpose of this Summary is to present some concepts of the claimed subject matter in a simplified form as a prelude to the more detailed description that is presented below.

In general, a “Visible Storage and Object Retrieval” (ViSOR) system, as described herein, provides a modular and interchangeable storage system for concurrently organizing, storing, protecting and viewing objects within various containers that are configured to interface with a wide variety of interchangeable storage devices and systems. These containers further include a fully or partially transparent or translucent window or the like that enables a user to view container contents without needing to open that container. For purpose of discussion, any such container of the ViSOR system will sometimes be referred to herein as a “windowed storage device.” As such, in various implementations, these windowed storage devices are configured to provide object visibility while preventing tangling, knotting, destruction, breakage, interweaving, etc., of or between jewelry or other objects contained therein.

More specifically, rather than merely providing a storage device having a transparent or translucent window for viewing internal contents, each windowed storage device of the ViSOR system is removably couplable or attachable to a wide range of “storage modalities” of the overall ViSOR system. In other words, one or more of the windowed storage devices are adapted to be removably coupled to, and interchangeable between, multiple storage modalities. In addition, in various implementations, the windowed storage devices are configured to be removably coupled to any of the multiple storage modalities either directly, or via one or more “intermediary connectors” that are themselves configured to be removably coupled to any of the storage modalities. As such, use of these intermediary connectors enables windowed storage devices to be quickly and easily moved or transferred between any of a plurality of different storage modalities of the overall ViSOR system. Further, in various implementations, one or more of the storage modalities may also function as intermediary connectors for being removably coupled to other intermediary connectors and/or other storage modalities. Finally, in additional implementations, the ViSOR system also includes a computer-based monitoring and access system in combination with a plurality of sensor devices that enable a wide range of computer-based applications and interactions with the ViSOR system.

For example, in one implementation, the ViSOR system includes a windowed storage device. In this exemplary implementation, the windowed storage device also includes a closable opening for accessing an interior of the windowed storage device. As described throughout this document, the windowed storage device also includes a window that forms at least a portion of one or more surfaces of the windowed storage device. Advantageously, this window is configured to provide a view from an exterior of the windowed storage device of one or more items secured within the windowed storage device. In addition, a plurality of securing mechanisms are disposed on one or more interior surfaces of the windowed storage device. Advantageously, these securing mechanisms are configured to secure one or more items within the interior of the windowed storage device in positions such that those items are viewable through the window from the exterior of the windowed storage device. Finally, in this exemplary implementation, one or more intermediary connectors are disposed on one or more exterior surfaces of the windowed storage device. Advantageously, these intermediary connectors are configured to be removably coupled to one or more storage modalities for removably coupling the windowed storage device to the one or more storage modalities via the one or more intermediary connectors.

Similarly, in another implementation, the ViSOR system comprises a plurality of sealable windowed storage devices, with each windowed storage device being configured to provide access to an interior of that windowed storage device via a sealable opening. Further, each of these windowed storage devices further comprises a window forming at least a portion of one or more surfaces of each windowed storage device. Advantageously, each window is configured to provide a view of an interior of a corresponding one of the windowed storage devices from an exterior of that corresponding windowed storage device. In addition, each windowed storage device further comprises a plurality of securing mechanisms disposed on one or more interior surfaces of each windowed storage device. Advantageously, these securing mechanisms are configured to secure one or more items within the interior of a corresponding one of the windowed storage devices in positions such that the secured items are viewable through the window from the exterior of that corresponding windowed storage device. Additionally, one or more intermediary connectors are disposed on one or more exterior surfaces of each windowed storage device. Finally, in this exemplary implementation, one or more storage modalities are removably coupled to one or more of the intermediary connectors, thereby removably coupling the corresponding windowed storage devices to those storage modalities via the corresponding intermediary connectors.

Similarly, in yet another implementation, various components of ViSOR system enable a method that provides a view from an exterior of a windowed storage device to an interior of the windowed storage device via a window forming at least a portion of the windowed storage device. Further, this method applies a plurality of securing mechanisms disposed on one or more interior surfaces of the windowed storage device to secure one or more items within the interior of the windowed storage device. Advantageously, these items are secured in positions such that the secured items are viewable through the window from the exterior of the windowed storage device. Finally, in this exemplary implementation, the method continues by applying an intermediary connector coupled to the windowed storage device to couple the windowed storage device to a storage modality.

### BRIEF DESCRIPTION OF THE DRAWINGS

The specific features, aspects, and advantages of the claimed subject matter will become better understood with regard to the following description, appended claims, and accompanying drawings where:

FIG. 1 illustrates an exemplary front view of a “windowed storage device” of a “Visible Storage and Object Retrieval” (ViSOR) system, as described herein.

FIG. 2 provides an exemplary operational flow diagram that illustrates various hardware and optional computing devices and subprograms for implementing the ViSOR system, as described herein.

FIG. 3 illustrates an exemplary top view of a windowed storage device, shown in a partially open configuration with a view of an interior of the windowed storage device, as described herein.

FIG. 4 illustrates an exemplary side view of a windowed storage device, shown with an optional intermediary connector coupled to a back surface of the windowed storage device, as described herein.

FIG. 5 illustrates an exemplary side view of a windowed storage device, shown with a plurality of different optional intermediary connectors coupled to a back surface of the windowed storage device, as described herein.

FIG. 6 illustrates an exemplary front view of a windowed storage device, shown with a zipper-based top opening, as described herein.

FIG. 7 illustrates an exemplary front view of a windowed storage device, shown with a zipper-based front opening, as described herein.

FIG. 8 illustrates an exemplary side view of a windowed storage device in a box-type format, shown with an optional intermediary connector coupled to a bottom surface of the windowed storage device, as described herein.

FIG. 9 illustrates an exemplary perspective view of the windowed storage device of FIG. 8, as described herein.

FIG. 10 illustrates an exemplary front view of a plurality of windowed storage devices removably coupled to an intermediary connector in the form of a panel or sheet, as described herein.

FIG. 11 illustrates a side view of an exemplary wall or surface mountable storage modality of the ViSOR system, this storage modality including a plurality of hooks or channels for removable coupling to either or both windowed storage modalities and intermediary connectors, as described herein.

FIG. 12 illustrates an exemplary front view of the storage modality of FIG. 11, as described herein.

FIG. 13 illustrates a side view of the exemplary storage modality of FIG. 11, shown with a first removably coupled windowed storage device and intermediary connector similar to that of FIG. 4 and shown with a second removably coupled windowed storage device and intermediary connector similar to that of FIG. 8, as described herein.

FIG. 14 illustrates a front view of an exemplary storage modality in the form of a hanger system that is removably coupled to a plurality of intermediary connectors in the form of either or both a rod and an s-hook that are in turn removably coupled to a plurality of windowed storage devices, as described herein.

FIG. 15 illustrates a front view of an exemplary storage modality in the form of a sheet or panel that is removably coupled to an intermediary connector in the form of a rod, the storage modality further being removably coupled to a plurality of windowed storage devices, as described herein.

FIG. 16 illustrates a front view of an exemplary storage modality in the form of a hanger system similar to that of FIG. 14 that is removably coupled to a plurality of intermediary connectors in forms including rods, s-hooks, hangers, eye rings, eyelets, grommets, panels, etc., that are in turn removably coupled to a plurality of windowed storage devices, as described herein.

FIG. 17 illustrates a top view of an exemplary storage modality in the form of an optionally rotatable jewelry tree, this storage modality being further adapted to be removably coupled to intermediary connector rods the same as, or similar to, the rods illustrated in any or all of FIG. 14, FIG. 15 and FIG. 16, as described herein.

FIG. 18 illustrates a side view of the storage modality of FIG. 17 that is removably coupled to a plurality of intermediary connector rods that are in turn removably coupled either directly to a plurality of windowed storage devices, or to other intermediary connectors (e.g., s-hooks and panels) that are in turn removably coupled, linked, strapped, interweaved, etc., to a plurality of windowed storage devices, as described herein.

FIG. 19 illustrates a general system diagram that depicts a variety of alternative computing systems, communications interfaces, and other physical components and devices for use in effecting various implementations of the ViSOR system, as described herein.

FIG. 20 illustrates a general system flow diagram that illustrates exemplary techniques for effecting various implementations of the ViSOR system, as described herein.

FIG. 21 illustrates a general system flow diagram that illustrates exemplary techniques for effecting various implementations of the ViSOR system, as described herein.

FIG. 22 illustrates a general system flow diagram that illustrates exemplary techniques for effecting various implementations of the ViSOR system, as described herein.

FIG. 23 is a general system diagram depicting a simplified general-purpose computing device having simplified computing and I/O capabilities for use in effecting various implementations of the ViSOR system, as described herein.

### DETAILED DESCRIPTION

In the following description of various implementations of a “Visible Storage and Object Retrieval” (ViSOR) system, reference is made to the accompanying drawings, which form a part hereof, and in which is shown by way of illustration specific implementations in which the ViSOR system may be practiced. Other implementations may be utilized, and structural changes may be made, without departing from the scope thereof.

Specific terminology will be resorted to in describing the various implementations described herein, and it is not intended for these implementations to be limited to the specific terms so chosen. Furthermore, each specific term includes all its technical equivalents that operate in a broadly similar manner to achieve a similar purpose. Reference herein to “one implementation,” or “another implementation,” or an “exemplary implementation,” or an “alternate implementation” or similar phrases, means that a particular feature, a particular structure, or particular characteristics described in connection with the implementation can be included in at least one implementation of the ViSOR system. Similarly, reference to the use of particular materials used in manufacturing various components of the ViSOR system including, but not limited to, natural materials such as fabrics, wood, metals, etc., plastics, polyethylene, moldable polymers, pliant polyurethane, synthetic organic materials, nylon, fabrics, weaves, and other composite materials, are not intended to limit those components to the use of the particular materials described. Further, the appearance of such phrases, and discussion of any particular materials, throughout the specification are not necessarily all referring to the same implementation, and separate or alternative implementations are not mutually exclusive of other implementations. The order described or illustrated herein for any process flows representing one or more implementations of the ViSOR system does not inherently indicate any requirement for the processes to be implemented in the order described or illustrated, and any such order described or illustrated herein for any structure or process flows do not imply any limitations of the ViSOR system.

As utilized herein, and depending upon the context, the terms “component,” “system,” “client” and the like are sometimes intended to refer to a computer-related entity, either hardware, software (e.g., in execution), firmware, or a combination thereof. For example, a component can be a process running on a processor, an object, an executable, a program, a function, a library, a subroutine, a computer, or a combination of software, object and source code, and hardware. By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, to the extent that the terms “includes,” “including,” “has,” “contains,” variants thereof, and other similar words are used in either this detailed description or the claims, these terms are intended to be inclusive in a manner similar to the term “comprising” as an open transition word without precluding any additional or other elements.

### 1.0 INTRODUCTION

Existing storage devices or containers often fail to provide visibility of jewelry or other objects contained therein. As such, a user of these existing storage devices typically opens multiple such storage devices to view the contents in order to locate a particular item of interest. In contrast, the ViSOR system described herein provides a modular and interchangeable storage system for concurrently organizing, storing, transporting, protecting and viewing jewelry or other objects within various containers, storage containers, cases (e.g., customized suitcases, purses, clutches, travel totes, jewelry bags, jewelry cases, packs, etc.) that are configured to interface with a wide variety of interchangeable storage devices and systems. Further examples of such containers include, but are not limited to, pouches, bags, boxes, sleeves, or any other receptacle or storage device having a fully or partially transparent or translucent window or the like that enables a user to view container contents without needing to open that container. For purpose of discussion, any such container of the ViSOR system will sometimes be referred to herein as a “windowed storage device.” Advantageously, these windowed storage devices are configured to provide object visibility while preventing tangling, knotting, destruction, breakage, interweaving, etc., of jewelry or other objects contained therein.

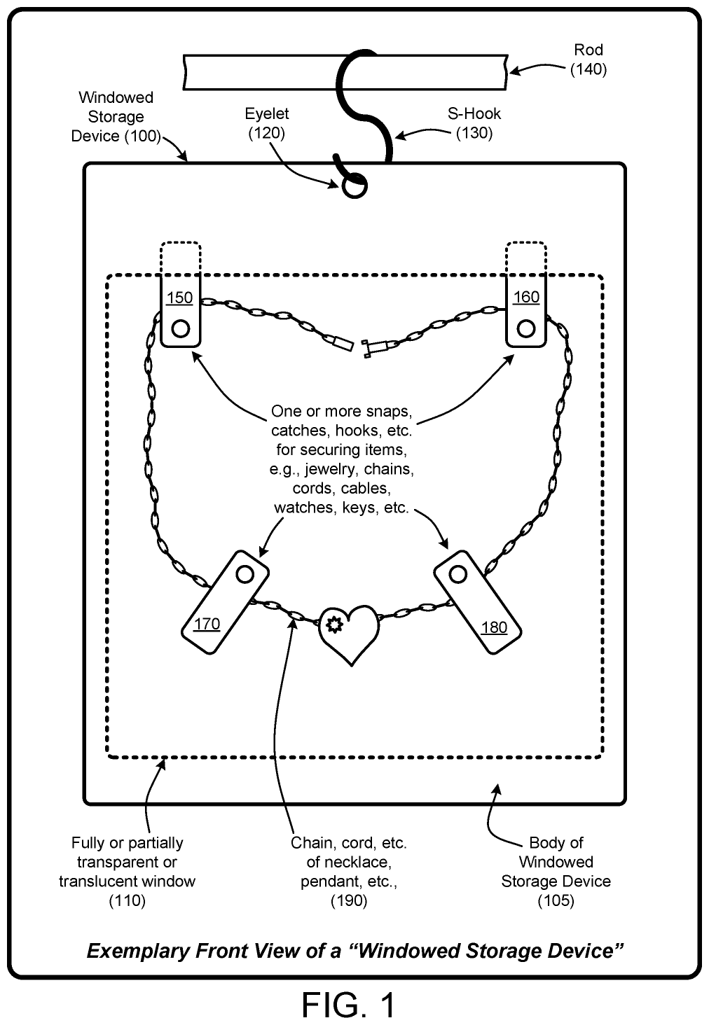

For example, FIG. 1 illustrates a front view of a simple example of a windowed storage device of the ViSOR system. Although not illustrated by FIG. 1, the windowed storage device 100 is configured to be opened, closed or otherwise sealed or unsealed (e.g., via seals or openings such as drawstrings, flaps, zippers, snaps, clasps, magnets, hook and loop type fasteners, etc.) along any of a front surface, a back surface and/or any edge of the windowed storage device to insert or remove objects.

By way of example, FIG. 1 shows a windowed storage device 100 in the form of a pouch, bag or the like. In this simple example, the windowed storage device 100 includes a body 105 comprising the pouch, bag or the like. In addition, the body 105 of the windowed storage device further includes a fully or partially transparent or translucent window 110 (delimited by broken lines) comprising, forming, or otherwise coupled to a portion of a front surface the body. Advantageously, this window 110 enables direct viewing of contents within the windowed storage device 100 from a viewpoint external to the windowed storage device.

In the example of FIG. 1, the windowed storage device 100 includes an optional eyelet 120, grommet, or the like. However, rather than being limited to use of eyelets or the like for coupling to intermediary connectors, in various implementations described in further detail herein, the windowed storage device 100 includes any of a wide range of connector types for removably coupling the windowed storage device to either or both a wide range of intermediary connectors and a wide range of storage modalities.

Inclusion of an eyelet 120 or the like enables the windowed storage device 100 to be removably coupled to intermediary connectors, such as for example an s-hook 130 or other connector that is in turn removably coupled to any of a variety of storage modalities such as rod 140. More specifically, FIG. 1 illustrates the use of eyelets 120, or grommets or the like as permanently coupled intermediary connectors for removable connection to an s-hook 130 (or other intermediary connector or storage modality) that is itself a removably coupled intermediary connector with respect to both the windowed storage device 100 and with respect to rod 140. In this case, the rod 140 can be yet another intermediary connector or can instead be considered to be a storage modality. For example, in the case that the rod 140 represents a closet rod or the like, it can be considered to represent a storage modality. In contrast, if the rod 140 is instead coupled to yet another intermediate connector or to a different storage modality, that rod can be considered to represent an intermediary connector.

Further, in various implementations, the windowed storage device 100 includes one or more connectors or securing mechanisms (e.g., 150, 160, 170 and 180) for securing items within the windowed storage device in a manner that provides object visibility via the window 110 while acting to prevent tangling, knotting, destruction, breakage, interweaving, etc., of those items. Examples of such connectors or securing mechanisms (e.g., 150, 160, 170 and 180) include, but are not limited to, snaps, catches, hooks, slots, magnets, etc. For example, as illustrated, FIG. 1 shows a chain, cord, etc., of a necklace or pendant 190 secured within the windowed storage device 100 via connectors or securing mechanisms 150, 160, 170 and 180. The broken line segments of connectors or securing mechanisms 150 and 160 illustrate sections of those connectors that are covered by at least a portion of the body 105 of the windowed storage device 100 and are thus not visible through the window 110, while the solid line segments of connectors 150, 160, 170 and 180 illustrate sections of these connectors that are visible through the window 110.

Advantageously, as mentioned, rather than merely providing a storage device having a transparent or translucent window for viewing internal contents, each windowed storage device of the ViSOR system is removably couplable to a wide range of storage modalities of the overall ViSOR system. In other words, one or more of the windowed storage devices are adapted to be removably coupled to, and interchangeable between, multiple storage modalities. In addition, one or more storage modalities of the ViSOR system may be appended to or removably coupled to clothes or attire normally associated and worn with a piece of bespoke jewelry or other object. For example, a jewelry owner in designing their dress and jewelry ensemble for the day, must open some or all their jewelry pouches and boxes to see what's inside in order to appropriately pair particular jewelry items with a desired outfit for that particular day. This can often be a frustrating, time-consuming burden for successful people on the go. Advantageously, the ViSOR system solves this and other problems by removing the frustration and anxiety associated with looking for a discreet/bespoke piece of jewelry that the user knows they have somewhere, but just can't see to find. Advantageously, as mentioned, in various implementations, the windowed storage devices are configured to interface with (i.e., be removably coupled to) any of the multiple storage modalities either directly, or via an intermediary connector that itself is configured to be removably coupled to any of the storage modalities. Advantageously, use of these intermediary connectors enables windowed storage devices to be quickly and easily moved or transferred between any of a plurality of different storage modalities of the overall ViSOR system. As yet another advantage, in various implementations, one or more of the storage modalities may also function as intermediary connectors for being removably coupled to other intermediary connectors and/or other storage modalities.

In other words, one or more of the windowed storage devices may be directly removably coupled to any of the storage modalities. Alternatively, or in addition, any of these windowed storage devices may be removably coupled to an intermediary connector that is further removably coupled to any of the storage modalities. As such, any of the windowed storage devices may be removably coupled to a plurality of storage modalities and/or a plurality of intermediary connectors each of which are themselves removably coupled to a plurality of storage modalities. In general, intermediary connectors include, but are not limited to, any combination of one or more mechanical, magnetic or electromagnetic connections. Any intermediary connector coupled to one storage modality can be removed (i.e., uncoupled) from that storage modality along with any windowed storage devices that are permanently or removably coupled to that intermediary connector. That same intermediary connector, along with any windowed storage devices that are permanently or removably coupled to that intermediary connector, may then be coupled to same or a different one of the storage modalities.

Advantageously, in various implementations, one or more of the windowed storage devices, and/or one or more of the removable couplings between windowed storage devices, intermediary connectors and/or storage modalities, are lockable via mechanical and/or electromechanical locks. A wide variety of such locking mechanisms are known to those skilled in the art and will not be described in detail herein.

In further implementations, the ViSOR system includes a computer-based monitoring and access system that applies any of a wide range of passive and/or active communications systems, devices and/or protocols in combination with a plurality of sensor devices and one or more computing devices to enable a wide range of computer- or software-based applications (e.g., programs, subprograms, etc.), as described in further detail throughout this document.

1.1 System Overview:

As mentioned above, in various implementations, the ViSOR system provides a modular and interchangeable storage system for concurrently organizing, storing, protecting and viewing jewelry or other objects within various containers that are configured to interface with a wide variety of interchangeable storage devices and systems (sometimes collectively referred to herein as “storage components” or the like). In various implementations, the ViSOR system provides a portable, bespoke branded (e.g., brands or names associated with particular retailers, department stores, jewelers, etc.), elegant, protective, customized jewelry pouch or other windowed container that is tailored, with respect to either or both size and shape, to the piece being stored or purse carried, e.g., necklace sized, earring sized, bracelet sized, ring sized, etc. For example, in various implementations, the ViSOR system solves a common problem that many discerning jewelry owners suffer from in getting dressed for success, they cannot see through opaque pouches boxes or other containers that came with the purchase of such jewelry.

For example, the jewelry owner in designing their dress and jewelry ensemble for the day, must open some or all their jewelry pouches and boxes to see what is inside in order to appropriately pair them with the desired outfit for that particular day. This is often a frustrating, time-consuming burden for successful people on the go. Advantageously, the ViSOR system solves this and other problems by removing the frustration and anxiety of looking for a discreet or bespoke piece of jewelry that the user knows they have somewhere, but just can't see to find. The ViSOR system not only protects valuable jewelry, stores the users expensive personal property, allows the user to purse carry their jewelry in protective packaging (i.e., the windowed storage device), it allows the user to see it without having to open the pouch, box or other container to see what's inside. In other words, in various implementations, the ViSOR system provides an elegantly designed, custom sized, jewelry pouch or other container with a viewing window that allows the owner to see inside the pouch or container without having to open it.

Further, in various implementations, the ViSOR system is modular in design such that a single windowed storage device can hang on a hanger through an eyelet or other similar device or intermediary connector along with many other bespoke pouches or other windowed storage devices forming a complete carrying case system or the like for all the user's jewelry in one place, one portable case. For example, as a discriminating owner of many valuable and different jewelry pieces, the “dress for success” owner can safely (and protectively) carry multiple jewelry pouches or other windowed storage devices in their purse or clutch while changing out jewelry pieces on the fly as the day's events unfold, day event to evening event when on the go. Advantageously, various storage components of the ViSOR system are portable in luggage, or other mediums of transportation and can be permanently or removably stored in vaults or closets. As such, in various implementations, various storage components of the ViSOR system are intelligently designed to not only address the invisibility issue of jewelry or other objects sold in blackout-type retail packaging, but are also designed to prevent tangling, knotting, destruction, breakage, interweaving, etc., of valuable and unique pieces that may also hold significant sentimental value, e.g., birthday gift, anniversary remembrance, etc.

Further, the ViSOR system can be used for long-term storage once an item is placed inside any of the windowed storage devices. Advantageously, any such windowed storage device can be hung on or otherwise removably connected to any combination of intermediary connectors and storage modalities in a manner that enables viewing of the stored contents without removing those contents from its pouch or other windowed storage device. Such features enable the user to move pouches, or other windowed storage devices, in much the same manner that they would hang clothes in a closet, while providing the capability to sort or arrange various ViSOR storage components to various levels of desire for viewing (e.g., prioritization of jewelry) or long-term storage. Advantageously, this also means that one or more of the ViSOR storage components are easily accessible to grab on the go if just one piece of jewelry or other items or several at a time are desired. As such, one or more pieces of jewelry or other items can be individually stored within various easily accessible windowed storage devices, with such items never having to be removed from their windowed storage device unless being used. In other words, in various implementations, ViSOR storage components enable the owner of jewelry or other objects to see inside the optionally branded, elegant, protective, carry case representing any or all of the windowed storage devices such that the owner never again has to search through closed or opaque containers to find the “right piece.”

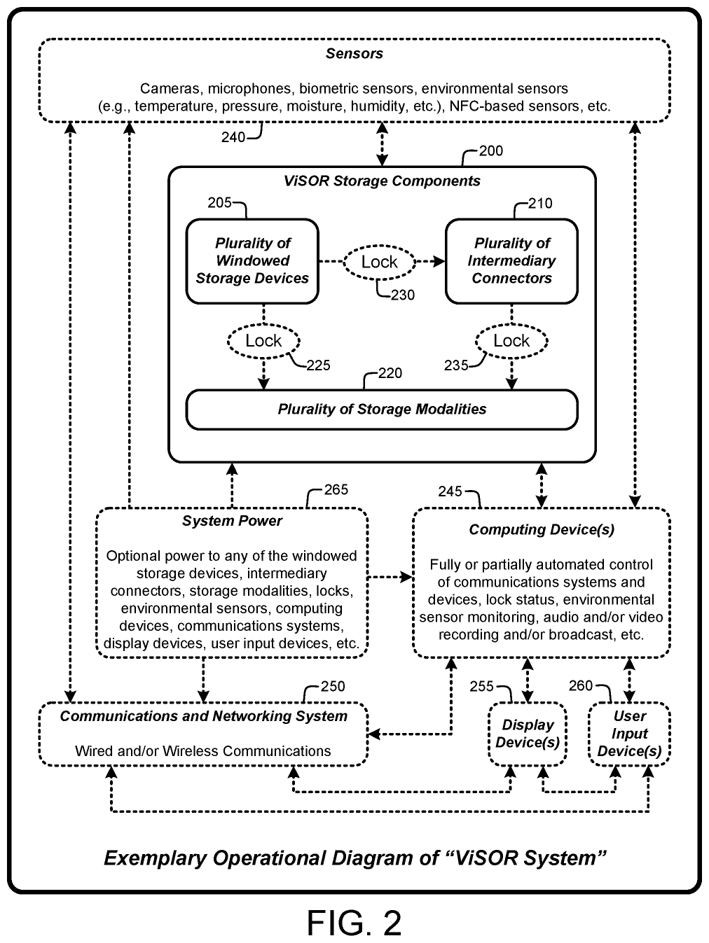

In related implementations, the ViSOR system is further configured to interface or interact with various storage components via a wide range of computer- or software-based applications. Some of the components and features summarized above are illustrated by the exemplary operational diagram of FIG. 2. In particular, the operational diagram of FIG. 2 illustrates various interrelationships between various physical components and optional software or computer-executable instructions for instantiating various implementations of the ViSOR system. Furthermore, while the operational diagram of FIG. 2 illustrates a high-level view of various implementations of the overall ViSOR system, FIG. 2 is not intended to provide an exhaustive or complete illustration of every possible implementation of the ViSOR system as described throughout this document.

In addition, any boxes and interconnections between boxes that may be represented by broken or dashed lines in FIG. 2 represent optional alternate implementations of the ViSOR system described herein, and any or all of these alternate implementations may be used in combination with other alternate implementations that are described throughout this document.

As illustrated by FIG. 2, in various implementations, the ViSOR system includes a set of storage components 200. In general, these storage components 200 consist of a plurality of windowed storage devices 205 (e.g., see FIG. 1) and any combination of a plurality of intermediary connectors 210 and storage modalities 220. In addition, in various implementations one or more locks (225, 230, 235) or locking mechanisms are applied for any or all of locking access to any of the windowed storage devices 205 and locking removable couplings between any combination of the windowed storage devices, the intermediary connectors 210 and the storage modalities 220. As discussed herein, any or all of these locks (225, 230, 235) may include, or otherwise be monitored by, active and/or passive electronic monitoring devices or sensors for use in monitoring and/or setting lock status and/or access by particular individuals. In other words, any or all of these locks (225, 230, 235) may be automatically monitored, controlled, locked, unlocked, etc., via one or more computing devices 245 in combination with the active and/or passive electronic monitoring devices or sensors.

More specifically, in various implementations, the ViSOR system includes a plurality of sensors 240 that are in communication with the one or more computing devices 245. Examples of sensors included in various implementations of the overall ViSOR system include, but are not limited to, still and/or video cameras, microphones, RFID readers and tags, Bluetooth or other NFC-based tags and scanners or readers, motion sensors, moisture and/or humidity sensors, temperature sensors, environmental pressure sensors, power level sensors, biometric scanners or sensor devices, etc.

In addition to the one or more computing devices 245, in various implementations, the ViSOR system further includes any or all of communications and networking system 250, display devices 255, and user input devices 260. Examples of communications systems, devices and/or protocols comprising the communications and networking system 250 include, but are not limited to, any of a wide range of passive and/or active near-field communications (NFC) communications protocols (e.g., RFID, Bluetooth, etc.), Internet of Things (loT) communications protocols, visual tracking systems (e.g., QR codes, barcodes, object recognition and tracking, or other visual identifiers), Wi-Fi, cellular communications, GPS, various networking and wired communications protocols, etc. For purpose of discussion, the aforementioned communications systems, devices and/or protocols will sometimes be collectively referred to herein as a “communications and networking system” or the like.

Examples of user input devices 260 of the ViSOR system include, but are not limited to, touchscreens, touch-sensitive surfaces, pointing devices, keyboards, audio input devices, voice or speech-based input and control devices, video input devices, haptic input devices, devices for receiving wired or wireless data transmissions, or any combination of such devices. These user input devices 260 are electronically coupled to, or otherwise in communication with, various sensors 240 and computing devices 245 of the ViSOR system via the communications and networking system 250 or via direct connection to one or more display devices 255.

Similarly, in various implementations, one or more of display devices 255 are electronically coupled to, or otherwise in communication with computing devices 245 via communications and networking system 250, or via direct connection to the computing devices and/or user input devices 260. In various implementations, either or both the display devices 255 and user input devices 260 include onboard or internal power (e.g., batteries, solar cells, NFC power transfer, etc.), or may draw operating power from computing devices 245. Alternatively, or in addition, either or both the display devices 255 and user input devices 260 may draw operating power from system power 265 (connections not illustrated for purpose of clarity).

In various implementations, system power 265 for some or all of the various components of the overall ViSOR system is optionally provided to any of the ViSOR storage components 200 (e.g., windowed storage devices 205, intermediary connectors 210, storage modalities 220, and locks (225, 230 and 235)). In addition, System power 265 is optionally provided to one or more of the sensors 240, computing devices 245, communications and networking system 250, display devices 255 and/or user input devices 260. Examples of system power 265 include, but are not limited to, any combination of batteries, capacitors, fuel cells, AC or DC power lines or supplies, internal or external generator, solar cells, NFC power sources, etc.

In various implementations, the combination of sensors 240, computing devices 245, communications and networking system 250, display devices 255, user input devices 260, and system power 265 are applied to enable a computer-based monitoring and access system. In various implementations, this computer-based monitoring and access system provides a wide range of computer-based applications relating to one or more of the ViSOR storage components 200. For purpose of discussion, this computer-based monitoring and access system will sometimes be referred to herein as a “ViSOR app” or the like. In other words, the ViSOR app represents a software-controlled combination of various computer hardware components, sensors, and networking and communications systems and devices for interacting with one or more of the ViSOR storage components 200 and/or associated sensors 240 via computing devices 245. As described herein, one or more ViSOR apps or computer programs may run or execute on any computing device including, but not limited to, portable devices such as a cell phone or tablet.

These ViSOR apps enable a wide range of functionality including, but not limited to, computer-based generation and/or updates of reports and/or databases relating to information such as, for example, object locations (e.g., jewelry or other objects secured within particular windowed storage devices along with the location of those windowed storage devices), cataloging and inventory of jewelry or objects secured within some or all windowed storage devices, alerts relating to access or attempted access to any locks or storage components of the ViSOR system, alerts relating to environmental conditions in the vicinity of any or all of the storage components of the ViSOR system, etc.

### 2.0 OPERATIONAL DETAILS OF THE VISOR SYSTEM

The above-summarized hardware, electrical, computer and software components are employed for instantiating various implementations of the ViSOR system. As summarized above, the ViSOR system provides a modular and interchangeable storage system for concurrently organizing, storing, protecting and viewing jewelry or other objects within various containers (e.g., windowed storage devices) that are configured to interface with a wide variety of interchangeable storage devices and systems. In related implementations, the ViSOR system is further configured to interface or interact with various storage components via either or both physical connections and via a wide range of computer- or software-based applications (e.g., “ViSOR apps”). The following sections provide a detailed discussion of the operation of various implementations of the ViSOR system, and of exemplary methods and techniques for implementing the features described in Section 1 with respect to FIG. 1 and FIG. 2. In particular, the following sections provides examples and operational details of various implementations of the ViSOR system, including:
An operational overview of the ViSOR system;
Windowed storage devices;
Intermediary connectors;
Storage modalities;
Locking modalities;
Computing, networking, power and sensor resources; and
Computer-based interactions with the ViSOR system.

2.1 Operational Overview:

Existing storage devices or containers often fail to provide visibility of jewelry or other objects contained therein. As such, a user of these existing storage devices typically opens multiple such storage devices to view the contents in order to locate a particular item of interest. In contrast, the ViSOR system described herein provides various implementations of a configurable protective and customizable system for holding jewelry or other objects within a pouch, bag, box, or any other receptacle or storage device in a manner that provides object visibility while preventing tangling, knotting, destruction, breakage, interweaving, etc., of jewelry or other objects contained therein.

As mentioned, for purpose of discussion, any pouch, bag, box, or any other receptacle or storage device of the ViSOR system will sometimes be referred to herein as a “windowed storage device.” Further, as summarized above, rather than merely providing a storage device having a transparent or translucent member (referred to herein as a “window”) for viewing internal contents, any windowed storage device of the ViSOR system is removably couplable to either or both a wide range of storage modalities and/or a wide range of intermediary connectors that are in turn removably couplable to one or more of the storage modalities.

Advantageously, some or all of the features of various implementations of the ViSOR system enable users to quickly view, retrieve, organize, protect, transport, etc., jewelry or other objects contained within pouches, bags, boxes, containers, or other windowed storage devices of the ViSOR system without needing to open each such windowed storage device to view the contents.

As a further advantage, the modularity and interchangeable nature of various windowed storage devices, intermediary connectors and storage modalities of the ViSOR system provides portability that enables users to carry a plurality of windowed storage devices (and the contents of those windowed storage devices) in a purse, backpack, suitcase, or other portable storage modality.

Similarly, as a further advantage, the modularity and interchangeable nature of various windowed storage devices, intermediary connectors and storage modalities of the ViSOR system provides a wide range of additional storage options that enables users to store a plurality of windowed storage devices (and the contents of those windowed storage devices) in or on fixed storage modalities such as filing cabinets, desk or dresser drawers, safes, vaults, etc.

As yet another advantage, the modularity and interchangeable nature of various windowed storage devices, intermediary connectors and storage modalities of the ViSOR system provides a wide range of additional storage options that enables users to store a plurality of windowed storage devices (and the contents of those windowed storage devices) in or on additional storage devices such as hooks, hangers, rods, jewelry trees, manual or automated retrieval systems (e.g., horizontally and/or vertically rotating holders), etc.

As a further advantage, as summarized above, in various implementations, the ViSOR system includes a computer-based monitoring and access system for interacting with, monitoring, and/or controlling one or more storage or other components of the ViSOR system.

2.2 Windowed Storage Devices:

In general, as illustrated with respect to FIG. 1 (discussed above) the windowed storage devices of the ViSOR system provide a modular and interchangeable container or the like that is adapted to enable a user to concurrently organize, store, protect and view jewelry or other objects. As defined herein, a “windowed storage device” is a physical device configured to secure objects within its interior while providing a view of those objects from its exterior via a window forming at least a portion of a surface of the windowed storage device.

These windowed storage devices may be fabricated in any desired size or shape and may have customized sizes and/or shapes that are designed to securely hold or store particular objects of a particular size and shape. Each of the windowed storage devices are configured to interface with either or both a wide variety of interchangeable intermediary connectors and storage modalities. Each windowed storage device includes one or more fully or partially transparent or translucent windows or the like that enable a user to view contents therein without needing to open the windowed storage device. One or more securing mechanisms (e.g., snaps, catches, clasps, magnets, hooks, loops, etc.) within each windowed storage device are configured to secure objects within the windowed storage device in a manner that provides object visibility through the one or more windows and that also reduces or prevents tangling, knotting, destruction, breakage, interweaving, etc., of the objects secured or contained therein. In various implementations, each windowed storage device is adapted to be removably coupled to either or both intermediary connectors and storage modalities. Further, in various implementations, one or more intermediary connectors are permanently affixed to the one or more of the windowed storage devices.

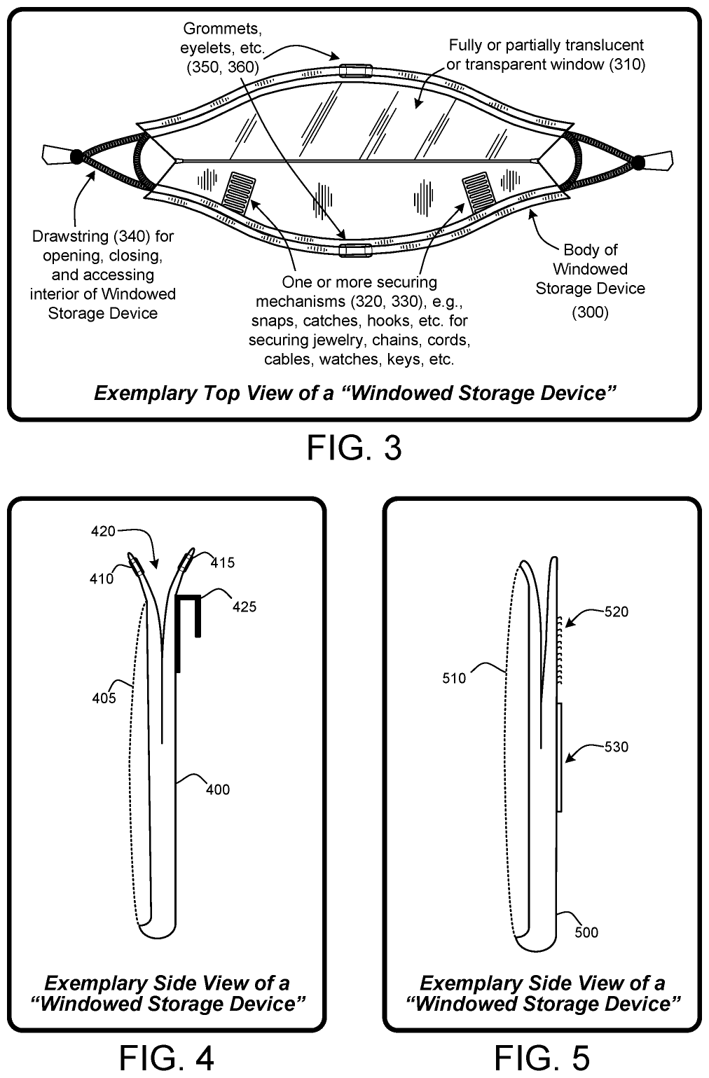

For example, FIG. 3 illustrates an exemplary top view of a windowed storage device 300 in the form of a pouch, bag, satchel, purse, or the like. FIG. 3 shows the windowed storage device 300 in a partially open configuration with a view of an interior of the windowed storage device through the open top of the windowed storage device. As illustrated by FIG. 3, the windowed storage device 300 includes a fully or partially translucent or transparent window 310 forming, or otherwise comprising a portion of, one or more surfaces of the windowed storage device. In addition, one or more securing mechanisms (320, 330), e.g., snaps, catches, clasps, magnets, hooks, loops, etc., within each windowed storage device 300 are coupled to or otherwise disposed within the windowed storage device in a position that enables objects to be secured within the windowed storage device in a position that enables those objects to be viewed through the window 310. In addition, as mentioned, these securing mechanisms (320, 330) serve to reduce or prevent tangling, knotting, destruction, breakage, interweaving, etc., of the objects secured within the windowed storage device 300.

As mentioned, each windowed storage device 300 is configured to opened and/or closed for insertion, removal or other access to objects within the windowed storage device. In the example of FIG. 3, one or more drawstrings 340 are applied to open and/or close a top opening of the windowed storage device. However, other mechanisms for opening and/or closing the windowed storage device 300 may be applied. Examples of such mechanisms, not shown in FIG. 3, include, but are not limited to, snaps, clasps, magnets, latches, or any other mechanical or electromechanical means for opening and/or closing the windowed storage device 300.

In addition, as mentioned, each windowed storage device is configured to either include, or be removably coupled to, one or more intermediary connectors. In the example of FIG. 3, the windowed storage device 300 includes one or more grommets, eyelets, etc. (350, 360) that act as intermediary connectors to enable the windowed storage device to be removably coupled to either or both other intermediary connectors and/or one or more storage modalities (not illustrated in FIG. 3). However, other mechanisms for removable coupling of the windowed storage device 300 to either or both intermediary connectors and storage modalities may be applied. Examples of such mechanisms, not shown in FIG. 3, include, but are not limited to, hooks, snaps, clasps, magnets, latches, c- or j-channel type connectors, hook and loop type fasteners, or any other mechanical or electromechanical means for removably coupling the windowed storage device 300 to either or both intermediary connectors and storage modalities.

For example, as illustrated by the side view of FIG. 4, an exemplary windowed storage device 400 in the form of a pouch or the like includes a window 405. In addition, the windowed storage device 400 includes integral grommets 410 and 415 positioned near a top opening 420 of the windowed storage device. These integral grommets 410 and 415 represent intermediary connectors for removable coupling of the windowed storage device 400 to another intermediary connector (not shown in FIG. 4) or to a storage modality (also not shown in FIG. 4). In addition, the example of FIG. 4 also illustrates a j-channel 425 or the like, that is either integral to, or removably coupled to, a back surface of the windowed storage device 400. This j-channel 425 represents a second intermediary connector that may be applied for removable coupling of the windowed storage device 400 to another intermediary connector (not shown in FIG. 4) or to a storage modality (also not shown in FIG. 4). See FIG. 13, discussed in further detail below, for an example of using a j-channel type connector for coupling of a windowed storage device to a storage modality.

Similarly, the side view of FIG. 5 illustrates an exemplary windowed storage device 500 in the form of a pouch or the like that includes a window 510. In addition, the windowed storage device 500 includes hook and loop type fasteners 520 that are either integral to, or removably coupled to, a back surface of the windowed storage device 500. These hook and loop type fasteners 520 represent an intermediary connector for removable coupling of the windowed storage device 500 to another intermediary connector (not shown in FIG. 5) having reciprocal hooks or loops or to a storage modality (also not shown in FIG. 5) having reciprocal hooks or loops. In addition, the example of FIG. 5 also illustrates a magnet 530 or a magnetic plate or the like that represents a second intermediary connector that may be applied for removable coupling of the windowed storage device 500 to another magnetic intermediary connector (not shown in FIG. 5) or to a magnetic storage modality (also not shown in FIG. 5).

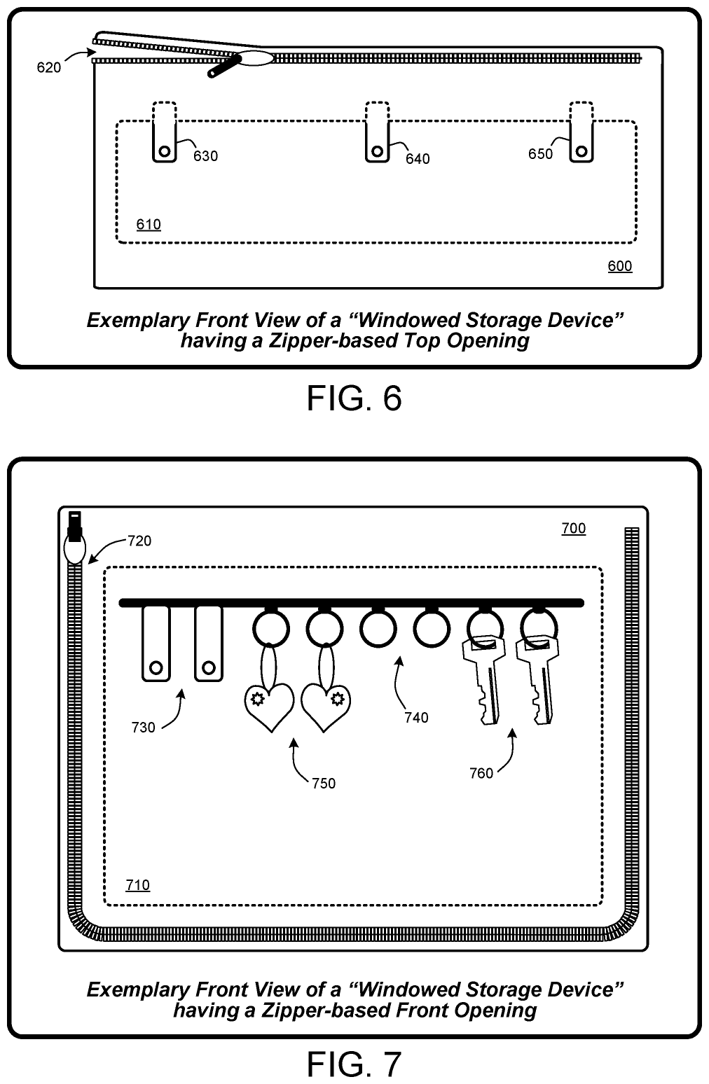

FIG. 6 through FIG. 9 illustrate additional implementations of windowed storage devices in various formats.

For example, FIG. 6 illustrates an exemplary front view of a windowed storage device 600 having a window 610 and including a zipper-based top opening 620. In addition, the windowed storage device 600 also includes a plurality of securing mechanisms (630, 640, 650), e.g., snaps, catches, clasps, magnets, hooks, loops, etc., with one or more of these securing mechanisms being positioned to enable objects to be secured within the windowed storage device in a position that enables those objects to be viewed through the window 610.

Similarly, FIG. 7 illustrates an exemplary front view of a windowed storage device having a window 710 and including a zipper-based front opening 720. In addition, the windowed storage device 700 also includes a plurality of securing mechanisms, e.g., a plurality of snaps 730 and a plurality of attachment rings 740. In the example shown, two of the attachment rings 740 are shown holding earrings 750 in a position such that those earrings are visible through the window 710. Further, in this example, two of the attachment rings 740 are shown holding keys 760 in a position such that those keys are visible through the window 710.

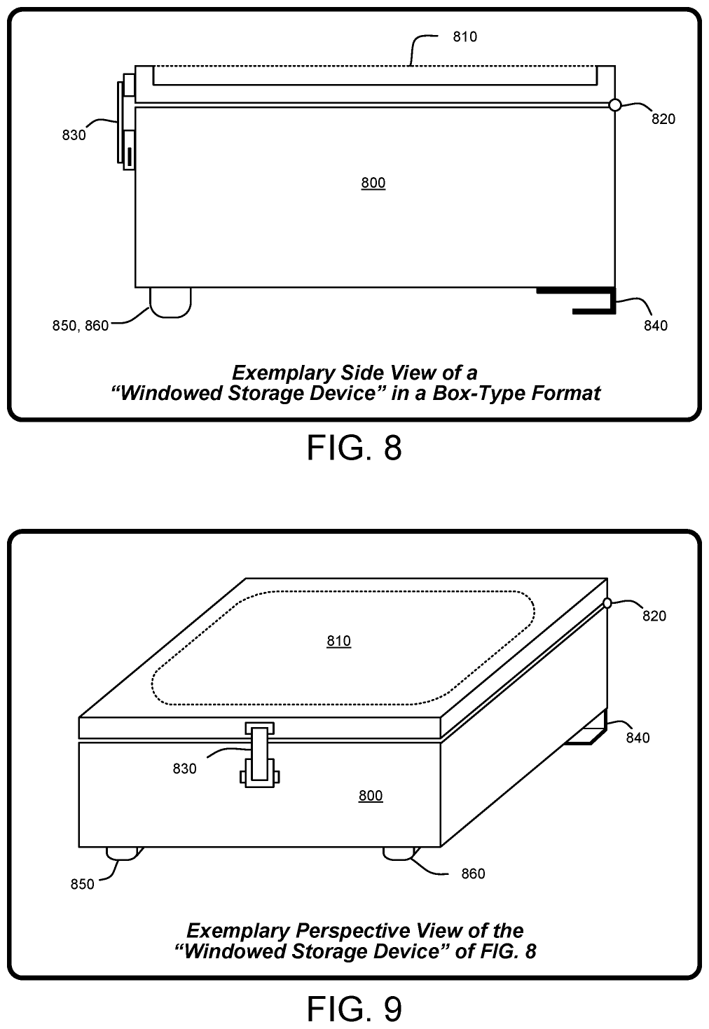

FIG. 8 illustrates another implementation of a windowed storage device 800. In particular, in the example of FIG. 8, the windowed storage device 800 is implemented in a box-type format having a window 810 in at least one surface of the windowed storage device. As illustrated, this box-type format includes a hinge 820 for opening and/or closing the windowed storage device 800. In addition, as illustrated, this windowed storage device includes an optionally lockable latch 830 or the like. Further, a bottom surface of the windowed storage device 800 includes a j-channel 840 or other connector that is either integral to, or removably coupled to, the bottom surface of the windowed storage device 800. This j-channel 840 represents an intermediary connector that may be applied for removable coupling of the windowed storage device 800 to another intermediary connector (not shown in FIG. 8) or to a storage modality (also not shown in FIG. 8). See FIG. 13, discussed in further detail below, for an example of using a j-channel type connector for coupling of a windowed storage device (similar to that illustrated by FIG. 8) to a storage modality. In addition, the example of FIG. 8 includes a plurality of optional feet or standoffs (850, 860) having heights approximately the same as that of the j-channel 840 type connector to enable the windowed storage device 800 to rest in a relatively level position on a surface. FIG. 9 simply illustrates an exemplary perspective view of the windowed storage device of FIG. 8.

In view of the preceding discussion, it is clear that the windowed storage devices of the ViSOR system are configured to provide a container that is modular in design such that it can interface with a wide range of various combinations of intermediary connectors and storage modalities while providing both visibility and protected storage for objects contained therein. These windowed storage devices may be of any desired shape (e.g., rectangular, round, hexagonal, regular or irregular polygons, etc.) or of any desired size for holding different pieces of jewelry or other objects (e.g., necklaces, earrings, bracelets, rings, keys, watches, USB memory sticks, tools, utensils, food items, etc.). Further, these windowed storage devices may include any of a variety of opening means (e.g., drawstrings, zippers, magnetic clasps, snaps, hook and loop type fasteners, etc.) and any variety of securing mechanisms (e.g., loops, hooks, magnets, snaps, clasps, etc.) for securing objects within the windowed storage devices.

Intermediary connectors for removable coupling to the windowed storage devices, other intermediary connectors, and/or various storage modalities are discussed in further detail in Section 2.3 of this document, while storage modalities for removable coupling to windowed storage devices and/or intermediary connectors are discussed in further detail in Section 2.4 of this document.

2.3 Intermediary Connectors:

In general, intermediary connectors include any of a wide variety of mechanical, electromechanical, and/or magnetic connections. As defined herein, an “intermediary connector” is a physical device that is configured to be permanently or removably coupled to any of the windowed storage devices and/or that are configured to be removably coupled to another intermediary connector or to a storage modality. Such mechanical, magnetic and/or electromechanical connections are well known to those skilled in the art, and include, but are not limited to, rods, hooks, shafts, cables, rings, keyrings, eyelets, carabiners, spring snaps, binder rings, chain connectors, rigid or flexible sheets, rigid or flexible panels, magnets or magnetic materials, hook and loop type fasteners, or any other combination of one or more mechanical, magnetic or electromagnetic connections. In other words, intermediary connectors provide removable couplings between windowed storage devices and storage modalities, or between windowed storage devices and other intermediary connectors that may in turn be coupled to a storage modality.

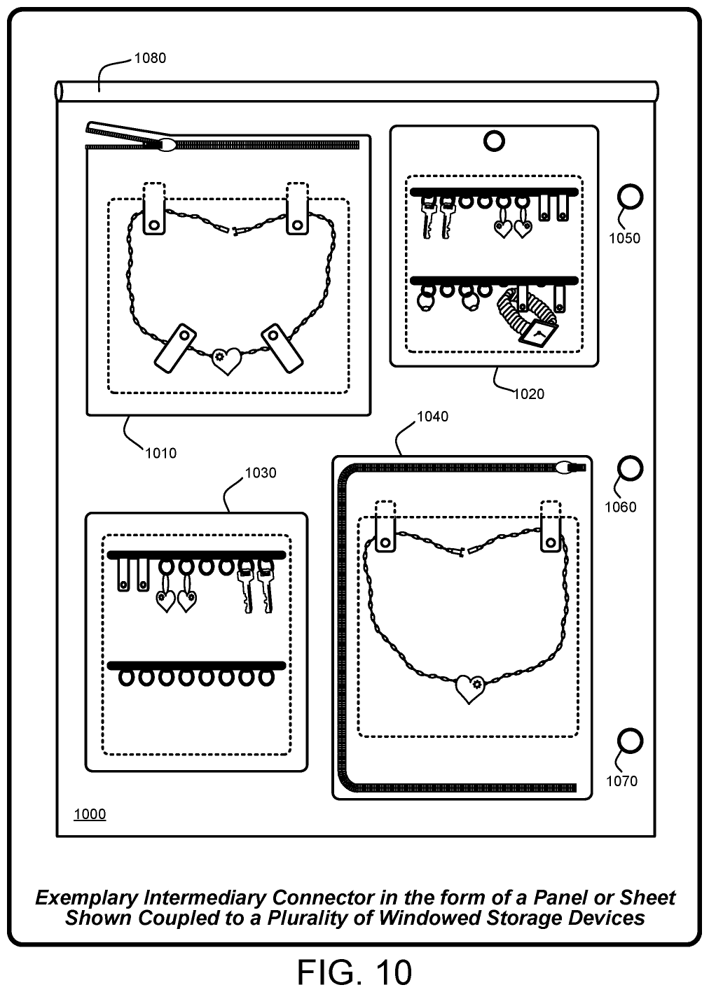

As mentioned, intermediary connectors are configured to be permanently or removably coupled to any of a plurality of the windowed storage devices of the ViSOR system. Further, one or more of the windowed storage devices may be removably coupled to one or more storage modalities. Alternatively, any of these windowed storage devices may be permanently or removably coupled to one or more intermediary connectors that are in turn removably coupled to any of the storage modalities or to another intermediary connector. Alternately, or in addition, some or all of the intermediary connectors, with or without coupled windowed storage devices, are configured to be removably coupled to either or both other intermediary connectors and various storage modalities. Similarly, any intermediary connector coupled to one storage modality can be removed (i.e., uncoupled) from that storage modality along with any windowed storage devices that are coupled to that intermediary connector. That same intermediary connector, along with any windowed storage devices that are coupled to that intermediary connector, may then be coupled to same or a different one of the storage modalities. For example, FIG. 10 illustrates an exemplary front view of a device in the form of a flexible or rigid panel or sheet 1000 that is configured to act as either or both an intermediary connector and as a storage modality.

More specifically, the panel or sheet 1000 illustrated by FIG. 10 can be considered as a storage modality in the sense that a plurality of windowed storage devices (1020, 1020, 1030 and 1040) are removably coupled to a front of the panel or sheet via intermediary connectors between backs of each of the windowed storage devices and the front of the panel or sheet 1000. Although not illustrated by FIG. 10, the removable couplings between the various windowed storage devices (1020, 1020, 1030 and 1040) and the panel or sheet 1000 are accomplished using any desired mechanical, magnetic and/or electromechanical connections.

Alternately, the panel or sheet 1000 illustrated by FIG. 10 may also act as an intermediary connector. For example, as illustrated, the panel or sheet 1000 includes a plurality of eyelets (1050, 1060 and 1070) any or all of which may be coupled to either or both another intermediary connector and a storage modality. For example, consider sizing the panel or sheet 1000 and eyelets to approximate the size of a sheet of paper having conventional hole spacing for attachment to a three-ring binder or the like (not illustrated in FIG. 10). In this case, a plurality of panels or sheets 1000 can be directly coupled to the three-ring binder or the like which then acts as the storage modality for that plurality of panels or sheets, while the panels or sheets are then acting as intermediary connectors between the windowed storage devices (e.g., 1020, 1020, 1030 and 1040) and the three-ring binder.

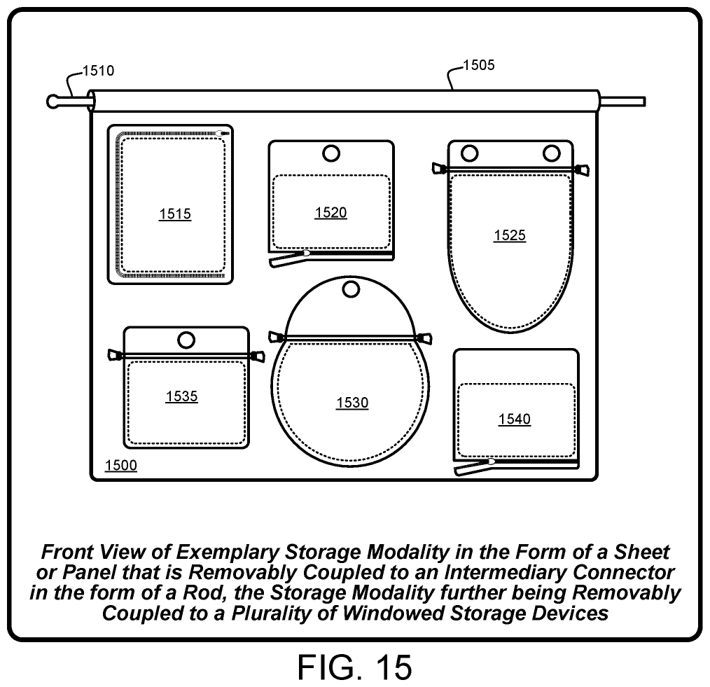

In addition, the panel or sheet 1000 illustrated by FIG. 10 may also act as an intermediary connector via a rod-pocket 1080 or the like that is configured to receive a rod (not illustrated in FIG. 10) that is in turn removably coupled to any of a plurality of storage modalities. For example, with respect to using hanging rods or the like, a typical bar or rod in a closet, cabinet, safe, etc., can support a hanger-type system for holding multiple pouches (e.g., similar to a standard hanger to hang up clothes). Smaller versions of bars or closet rods can be adapted to fit as inserts (with or without special brackets) into the standard holes that are typically used in combination with adjustable shelving seen in closets, bookcases, display racks, safes, etc. In addition, such bars can be adapted to interface with standard file cabinet drawers. For example, such a rod may be configured as a rod or bar having hooked ends or the like for removable coupling to the file folder rails in a standard file cabinet drawer or the like. Examples of some of these scenarios are described below with respect to FIG. 15 through FIG. 18.

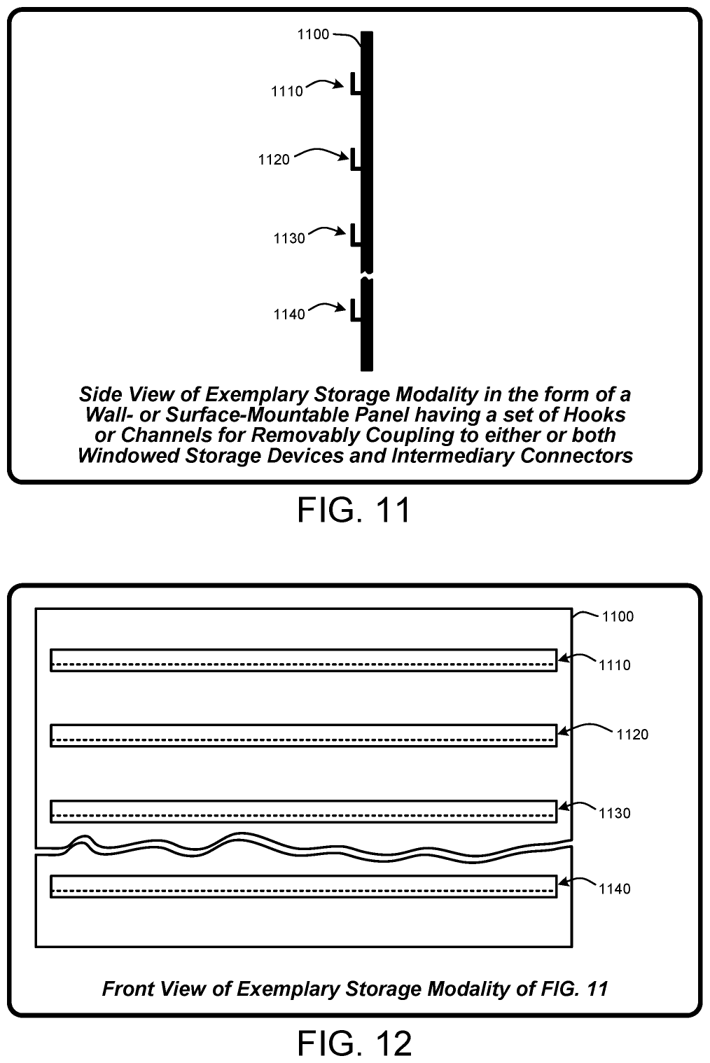

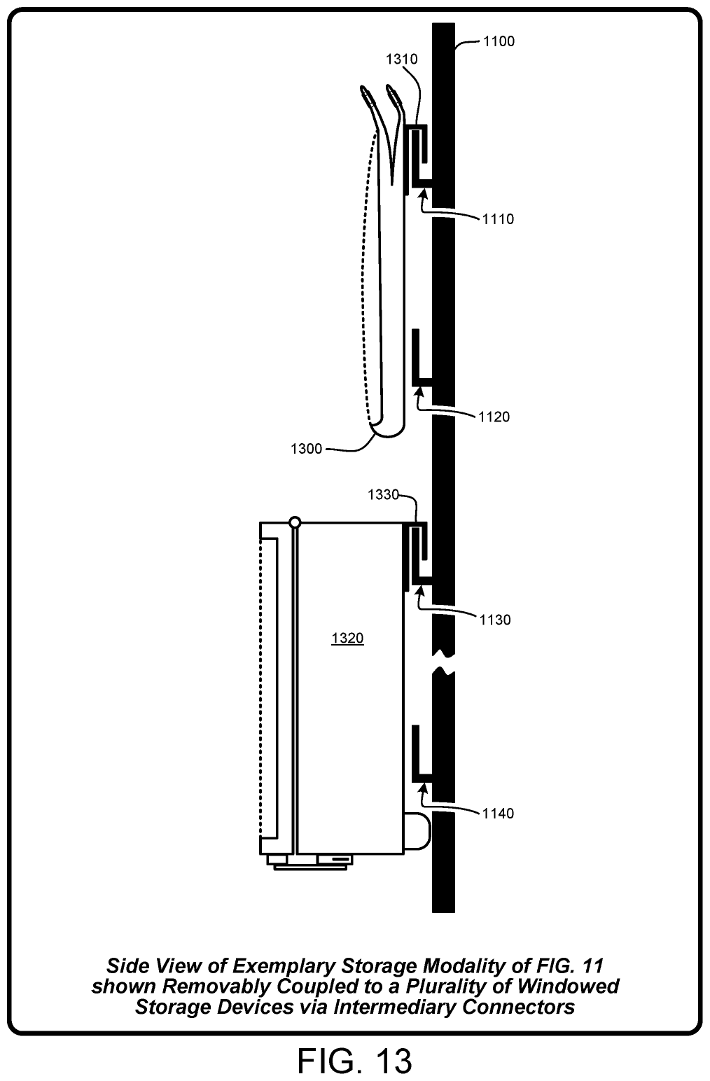

Referring now to FIG. 11, this figure illustrates a side view of an exemplary wall or surface mountable storage modality 1100 (e.g., a surface mountable panel or the like). As illustrated, this storage modality 1100 includes a plurality of hooks or j-channels (1110, 1120, 1130 and 1140) or the like for receiving a removable coupling to either or both windowed storage modalities (not shown in FIG. 11) and intermediary connectors (not shown in FIG. 11). FIG. 12 illustrates an exemplary front view of the windowed storage device of FIG. 11 showing a front face of the surface mountable panel or the like. FIG. 13 illustrates the same side view of the exemplary storage modality of FIG. 11. However, in contrast to FIG. 11, FIG. 13 illustrates a first removably coupled windowed storage device 1300 having a j-channel type intermediary connector 1310 similar to that of the windowed storage device 400 described with respect to FIG. 4. In other words, intermediary connector 1310 of the windowed storage device 1300 is removably coupled to storage modality 1100 via matching j-channel 1110. Similarly, FIG. 13 shows a second removably coupled windowed storage device 1320 having a j-channel type intermediary connector 1330 similar to that of the windowed storage device 800 described with respect to FIG. 8 and FIG. 9. In other words, intermediary connector 1330 of the windowed storage device 1320 is removably coupled to storage modality 1100 via matching j-channel 1130.

2.4 Storage Modalities:

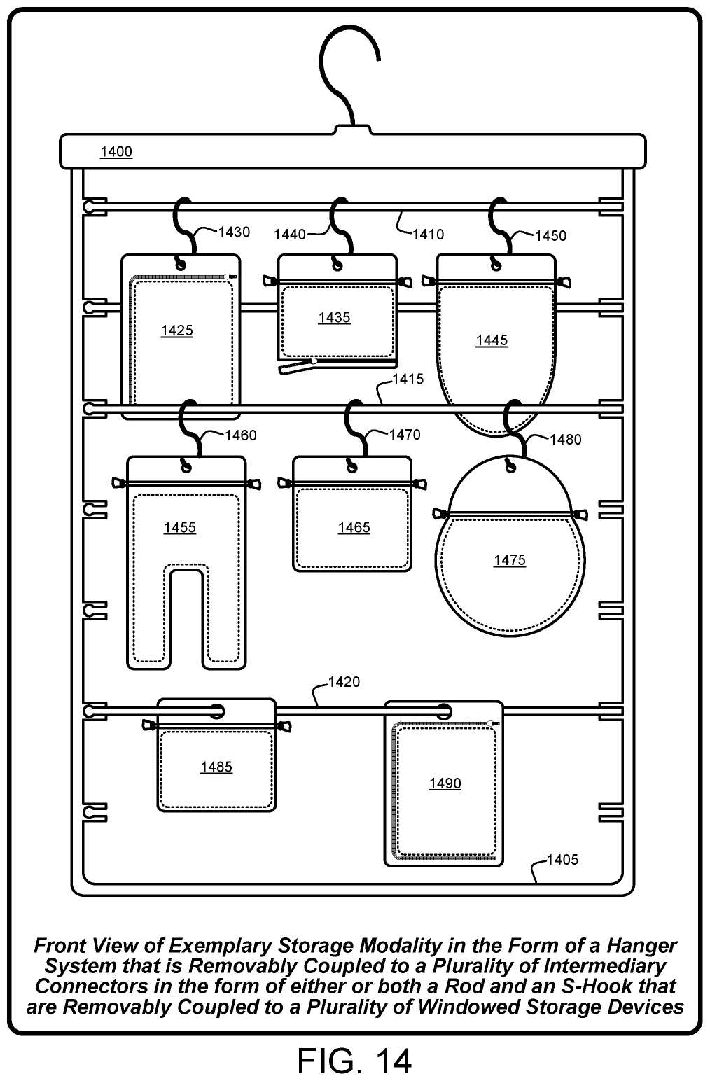

In various implementations, the ViSOR system includes a plurality of storage modalities. As defined herein, a “storage modality” is a physical device including, but not limited to, portable storage devices such as purses, backpacks, luggage, carrying cases, briefcases, satchels, fixed storage devices such as filing cabinets, desk or dresser drawers, safes, vaults, etc., or other storage devices such as hooks, hangers, rods, jewelry trees, manual or automated retrieval systems (e.g., horizontally and/or vertically rotating holders), etc., that is configured to be removably coupled to an intermediary connector and/or a windowed storage device. As mentioned, any of the storage modalities may be removably coupled to a plurality of windowed storage devices and/or a plurality of intermediary connectors each of which are themselves removably coupled to a plurality of windowed storage devices. In other words, one or more of the windowed storage devices may be directly removably coupled to any of the storage modalities. Alternatively, or in addition, any of these windowed storage devices may be removably coupled to an intermediary connector that is further removably coupled to any of the storage modalities. As such, any of the windowed storage devices may be removably coupled to a plurality of storage modalities and/or a plurality of intermediary connectors each of which are themselves removably coupled to a plurality of storage modalities. FIG. 14 through FIG. 18 demonstrate the interoperability of various windowed storage devices, various intermediary connectors and various storage modalities.

For example, FIG. 14 illustrates a combination of a storage modality with multiple different intermediary connectors and multiple different windowed storage devices. More specifically, FIG. 14 illustrates a front view an exemplary storage modality in the form of a hanger system 1400 for hanging on a closet rod or the like (not shown). This hanger system includes a keyed frame 1405 that is configured to receive a removable coupling to a plurality of keyed rods (1410, 1415 and 1420). These keyed rods (1410, 1415 and 1420) act as intermediary connectors for removable coupling to either or both a plurality of further intermediary connectors and windowed storage devices. More specifically, as illustrated, windowed storage devices (1425, 1435 and 1445) are removably coupled to keyed rod 1410 via s-hooks (1430, 1440 and 1450, respectively). In turn, keyed rod 1410 is removably coupled to keyed frame 1405 of the hanger system 1400. Similarly, windowed storage devices (1455, 1465 and 1475) are removably coupled to keyed rod 1415 via s-hooks (1460, 1470 and 1480, respectively). In turn, keyed rod 1415 is removably coupled to keyed frame 1405 of the hanger system 1400. Finally, windowed storage devices (1485, 1490 and 1445) are directly removably coupled to keyed rod 1420 without the use of further intermediary connectors. In turn, keyed rod 1420 is removably coupled to keyed frame 1405 of the hanger system 1400.

As discussed with respect to FIG. 10, a sheet or panel configured to be removably connected to a plurality of windowed storage devices may act as an intermediary connector. For example, FIG. 15 shows a panel 1500 having a rod pocket 1505 that is removably coupled to a keyed rod 1510. In addition, the panel 1500 is also removably coupled to a plurality of windowed storage devices (1515 through 1540). In various implementations, not illustrated in FIG. 15, the keyed rod 1510 is permanently coupled to panel 1500 or other intermediary connector or other windowed storage device.

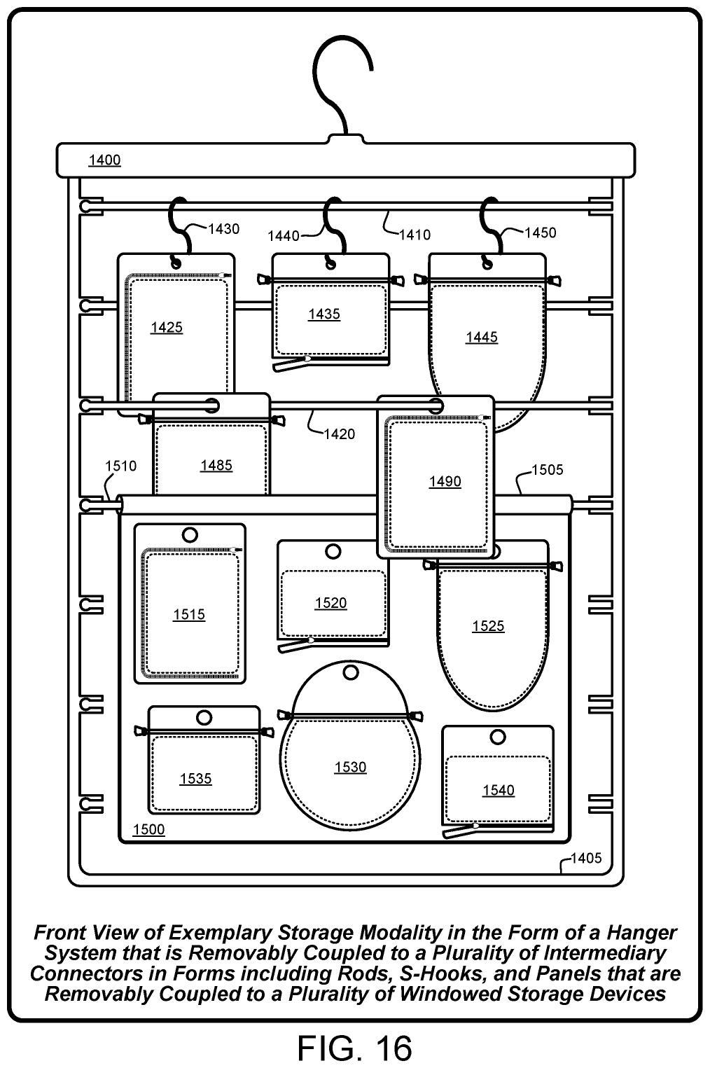

FIG. 16 provides a combination of FIG. 14 and FIG. 15 by illustrating the coupling of keyed rod 1510 to the keyed frame 1405. As discussed with respect to FIG. 15, FIG. 16 again illustrates panel 1500 having rod pocket 1505 that is removably coupled to keyed rod 1510. In addition, as with FIG. 15, FIG. 16 shows that panel 1500 is also removably coupled to the plurality of windowed storage devices (1515 through 1540). As such, windowed storage devices (1515 through 1540) are removably coupled to hanging system 1400 via the panel 1500 and the keyed rod 1510. In addition, FIG. 16 also shows that keyed rod 1420 with removably coupled windowed storage devices (1485 and 1490) has been moved to a higher position on keyed frame 1405.

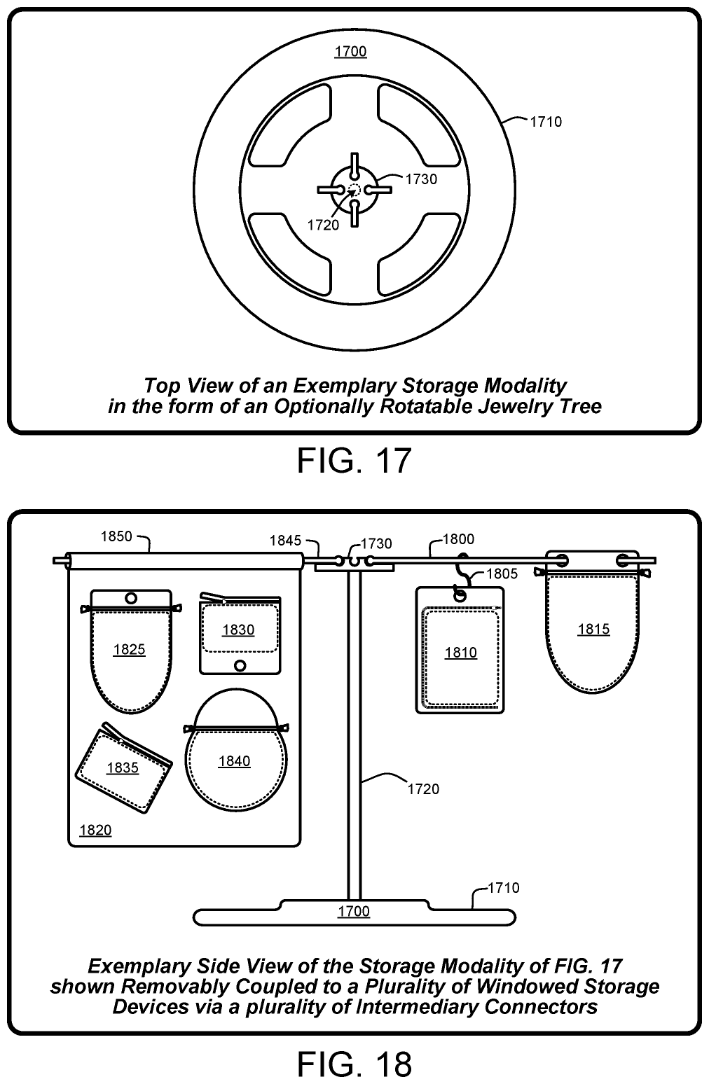

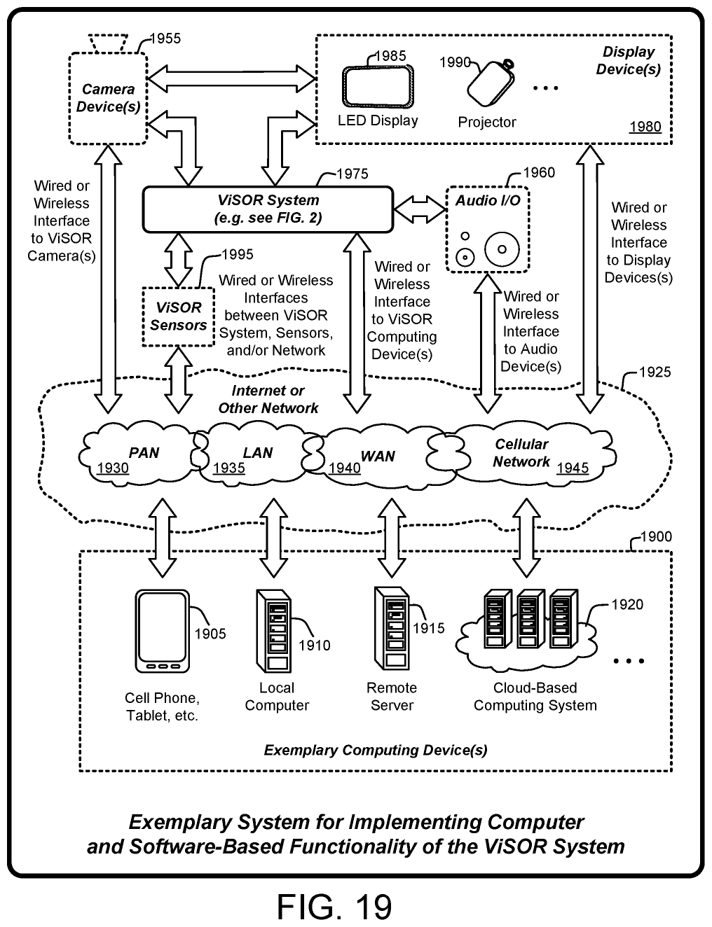

FIG. 17 and FIG. 18 illustrate another use of interchangeable keyed rods for yet another storage modality. For example, FIG. 17 illustrates a top view of an exemplary storage modality in the form of an optionally rotatable jewelry tree 1700. This jewelry tree 1700 includes a base 1710, a vertical shaft 1720, a first end (i.e., a bottom end) of which is coupled to and extends upwards from the base 1710. In addition, a keyed rod holder 1730 (configured to be removably coupled to a plurality of keyed rods, not illustrated in FIG. 17) is coupled to a second end (i.e., a top end) of the vertical shaft. In various implementations, either or both of the couplings of the vertical shaft 1720 are rotatable couplings, thereby enabling the keyed rod holder 1730 to rotate in a plane parallel to that of the base 1710. FIG. 18 illustrates a side view of the jewelry tree 1700 of FIG. 17. In the example of FIG. 18, the keyed rod holder 1730 is removably coupled to keyed rod 1800, with keyed rod 1800 extending from and being supported in a horizontal position by the keyed rod holder 1730. In turn keyed rod 1800 is removably coupled to s-hook 1805 which is in turn removably coupled to windowed storage device 1810 via grommets, eyelets or the like of the windowed storage device 1810. Further, windowed storage device 1815 is removably coupled to keyed rod 1800 via grommets, eyelets or the like of the windowed storage device 1815 without the use of further intermediary connectors. In addition, panel 1820 is removably coupled to a plurality of windowed storage devices (1825, 1830, 1835 and 1840) via any of a plurality of intermediary connectors (not illustrated in FIG. 18). Further, panel 1820 is removably coupled to keyed rod 1845 via rod pocket 1850. Finally, the keyed rod holder 1730 is removable coupled to keyed rod 1845, with keyed rod 1845 extending from and being supported in a horizontal position by the keyed rod holder 1730, thereby holding panel 1820 in an upright position, as shown.

2.5 Locking Modalities:

As mentioned, in various implementations, any of the windowed storage devices, and any connection between any of the windowed storage devices, intermediary connectors and/or storage modalities, are lockable via mechanical and/or electromechanical locks. In addition, any of the various storage modalities may be lockable (e.g., safes, vaults, desk drawers, suitcases, satchels, etc.) via various combinations of keyed locks, combination locks, biometric-based locks (e.g., fingerprints, facial recognition, voiceprints, etc.) Such locks are known to those skilled in the art and will not be described in detail herein.

In various implementations, some or all of the locking capabilities of the overall ViSOR system are adapted to grant access (e.g., automated locking and unlocking features) to authorized users or to prevent or otherwise deter unauthorized users from opening or accessing contents within the windowed storage devices or storage modalities. In addition, such locking capabilities are further adapted to grant access (e.g., automated locking and unlocking features) to authorized users or to prevent or otherwise deter unauthorized users from uncoupling windowed storage devices from intermediary connectors or from storage modalities. Further, such locking capabilities are adapted to grant access (e.g., automated locking and unlocking features) to authorized users or to prevent or otherwise deter unauthorized users from uncoupling intermediary connectors (along with any attached windowed storage devices) from any of the storage modalities.

In various implementations, some or all locking mechanisms associated with the ViSOR system are monitored via one or more of the sensor devices of the ViSOR system to generate alerts or other metadata upon access or attempted access to any of the locks by any person or persons. Further, in various implementations, these alerts or metadata include audible, visible, or networked alarms that are generated to alert users and/or one or more computing devices or ViSOR apps in the event of either or both authorized access and unauthorized access or attempted access to any locked component of the ViSOR system by any person or persons.

2.6 Computing, Networking, Power and Sensor Resources:

As mentioned, the ViSOR system may be implemented in combination with one or more local or remote computing devices, local or remote servers, cloud-based computing systems, etc., in combination with various tracking, networking and communications modalities and sensor devices to instantiate a computer-based monitoring and access system. For purpose of discussion, this computer-based monitoring and access system will sometimes be referred to herein as a “ViSOR app” or the like. In other words, the ViSOR app represents a software-controlled combination of various computer hardware components, sensors, and networking and communications systems and devices for interacting with one or more of the ViSOR storage components and/or associated sensors via one or more computing devices and associated hardware and communications.

Clearly, as will be well-understood by those skilled in the art, any or all of the computer-based or application-based features described throughout this document can be implemented via any desired combination of computational and communications resources. In particular, any one or more sufficiently capable (e.g., sufficient computational capacity, sufficient communications bandwidth, sufficient latency, etc.) computing devices, servers, or cloud-computing systems may be used to implement any or all of the various features and functions of the ViSOR app as described herein without departing from the intended scope of the concepts described. As such, modifying, adapting, combining, networking, etc., communications and interactions between any one or more such computing devices, servers or cloud-computing systems, sensors and hardware for implementing any or all of the features of the ViSOR system does not limit the subject matter of the ViSOR system as described herein.

For example, as illustrated by FIG. 19, various processes enabled by the computing resources of the ViSOR system are implemented by instantiating some or all of the control functionality of the ViSOR system on one or more computing devices 1900. Examples of computing devices 1900 include, but are not limited to, local computing device 1905 (e.g., cell phone, tablet, etc.), local computer 1910, remote server 1915, cloud-based computing system 1920, or any other computing device or system having sufficient computational resources.

Some or all of these computing devices 1900 are in communication with each other and/or in communication with the ViSOR system 1975 via various wired and/or wireless interfaces or protocols. In addition, the ViSOR system 1975 may be in communication with some or all of one or more camera devices 1955, one or more audio input and/or output devices 1960, one or more display devices 1980 (e.g., LED display 1985, projector device 1990, etc.), and one or more sensor devices 1995. Such communications are enabled via any of a wide range of communication and networking technologies.

For example, such communications are enabled via the internet or other network 1925, and include communications protocols and networks such as, for example, conventional wired or wireless networks including personal area networks (PAN) 1930, local area networks (LAN) 1935, wide area networks (WAN) 1940, cellular network 1945, etc., using any desired wired or wireless network topology (e.g., star, tree, etc.), connectivity, or protocol.

As discussed in further detail throughout Section 2 of this document, various semi- or fully automated implementations of the ViSOR system and or the ViSOR app operate in combination with any or all of the aforementioned computing devices 1900 and networks 1925 to provide control, statuses, communications, and/or interaction with various components of the ViSOR system.

2.6.1 ViSOR System Power:

In various implementations, one or more components of the ViSOR system includes any of a variety of onboard power sources including, but not limited to, batteries, fuel cells, solar cells, etc., wired power sources (e.g., one or more components of the ViSOR system connected to a home or building AC or DC power outlet or the like), or wireless power sources (e.g., NFC-based power sources). Use and connectivity of such power sources are known to those skilled in the art and will not be discussed in detail herein.

2.6.2 Local and/or Remote Sensors and Sensor Monitoring:

In various implementations, the ViSOR system (or one or more ViSOR apps) monitors various local and/or remote sensors or sensor information received from one or more internal sensors or sources of sensor information or one or more external sensors or sources of sensor information. This monitoring of sensors and sensor information enables one or more ViSOR apps associated with the ViSOR system to report, evaluate or otherwise react or respond to various statuses and conditions associated with any or all of the various storage components of the ViSOR system.

For purposes of explanation, various sensors will be described as if integral to the ViSOR system. However, in various implementations, any or all such sensors are connected to (or in the physical vicinity of) particular components of the ViSOR system (e.g., coupled to or in the vicinity of one or more windowed storage devices, intermediary connectors, storage modalities, etc.). Further, any or all such sensors may be in communication with one or more computing devices of the ViSOR system via any known wired or wireless communications interface or protocol.

For example, in various implementations, such sensors include, but are not limited to, any or all of the following:
a. Still and/or video cameras, e.g., fixed, directional, or 360-degree view in or near any component of the ViSOR system;
b. Microphones configured to capture audio signals (including, but not limited to, user voice commands relating to one or more ViSOR apps);
c. RFID, Bluetooth or other NFC-based tags, scanners and/or readers, with corresponding tags coupled to one or more of the storage components of the ViSOR system and/or coupled to one or more of the objects stored within any of the storage components of the ViSOR system;
d. Optical tags (e.g., barcodes, QR-codes, or other visual indictors) coupled to one or more of the storage components of the ViSOR system and/or coupled to one or more of the objects stored within any of the storage components of the ViSOR system, these optical codes capable of being scanned by various optical tag readers or still or video cameras associated with any ViSOR app;
e. Motion sensors, e.g., infrared, microwave, ultrasonic, laser, etc., that are configured to detect motion of any of the storage components of the ViSOR system and/or motion near any of the storage components of the ViSOR system;
f. Water, humidity and/or moisture sensors configured to monitor and report water, humidity and/or moisture levels in or near one or more of the storage components of the ViSOR system;
g. Temperature sensors, e.g., thermocouples, infrared, etc., configured to monitor and report temperature levels in or near one or more of the storage components of the ViSOR system;
h. Environmental pressure sensors configured to monitor and report pressure levels in or near one or more of the storage components of the ViSOR system;
i. Power level sensors (e.g., battery levels, power draw, etc.) configured to monitor and report power information associated with any component of the ViSOR system;
j. External alarms or alerts (e.g., fire alarms, intrusion alarms, etc.).

2.7 Computer-Based Interactions with the ViSOR System:

As mentioned, in various implementations, one or more ViSOR apps are configured to provide software-based interactions with various components of the ViSOR system based on various sensor inputs (as discussed throughout this document). For example, in various implementations, some or all of the functionality of the ViSOR system is partially or fully automated via an application or computer program or the like running on any computing device (e.g., smart phone, tablet, desktop computer, server, cloud-based computing system, etc.) that is configured to communicate via wired or wireless connections with one or more controls, switches, sensors or computing devices of the ViSOR system for purposes of controlling, activating, or otherwise interacting with one or more features or functions of the ViSOR system.

In various implementations, control of various configurations and functions of the ViSOR system via such computing devices and communications modalities is achieved via local and/or remote interaction with and control of those computing devices. Such local and/or remote control provides any combination of direct local control, local or remote app-based control via cell phones, tablet-type devices, or other computing resources, etc., that communicate with one or more computing or control devices and/or sensors associated with the ViSOR system. In various implementations, the app-based control provides partially or fully automated functionality of the ViSOR system including, but not limited to, monitoring and/or reporting or responding to outputs of various sensors coupled to or otherwise in communication with the ViSOR system, monitoring and/or reporting or responding to status of one or more components of the ViSOR system, recording and/or transmission of audio, images, or video recorded by microphones and/or cameras coupled to or otherwise in communication with the ViSOR system, etc.

For example, in various implementations, the aforementioned computational, sensor and communications capabilities are applied to enable a ViSOR app that applies various combinations of computer-based sensor monitoring via various well-known passive and/or active near-field communications modalities (e.g., RFID, Bluetooth, etc.), visual tracking systems (e.g., QR codes, barcodes, object recognition and tracking, or other visual identifiers), Wi-Fi, GPS, etc., to pinpoint locations of any of the windowed storage devices with respect to any of the intermediary connectors and/or with respect to any of the storage modalities associated with the overall ViSOR system.

In related implementations, another ViSOR app applies the aforementioned computational, sensor and communications capabilities are applied to enable a ViSOR app that applies various sensor-derived biometric information (e.g., fingerprints, voiceprints, facial recognition, etc.) to identify and/or authorize one or more persons accessing, or in the vicinity of, any of the windowed storage devices either individually and/or with respect to any of the intermediary connectors and/or with respect to any of the storage modalities associated with the overall ViSOR system.

In further related implementations, the aforementioned computational, sensor and communications capabilities are applied to enable a ViSOR app that monitors and/or controls a lock status (e.g., locked or unlocked) of one or more of the locks associated with the ViSOR system. In various implementations, such tracking of lock status also includes biometric information or other identifications of one or more persons accessing (e.g., locking and/or unlocking) any locks of the ViSOR system and may further include time and/or location metadata associated with any such access.

In further implementations, one or more of the windowed storage devices include RFID tags or other electronic or visual identifier means (e.g., Bluetooth tags, barcodes, QR-codes, etc.) that are collectively referred to herein as “identification modalities.” One or more of these identification modalities are coupled to (via either fixed or removable connections) any combination of individual stored objects, individual windowed storage devices, individual intermediary connectors and individual storage modalities. As such, any or all of these identification modalities are applied in combination with one or more ViSOR apps to maintain computerized tracking and/or inventory of one or more of the windowed storage devices, intermediary connectors, storage modalities and contents of any of the windowed storage devices.

Yet another exemplary ViSOR app is configured to accept and respond to user queries by determining which specific windowed storage device holds a particular piece or type of jewelry or some other item, and whether that specific windowed storage device is removably coupled to a particular closet hanger or some other intermediary connector, or whether that specific windowed storage device is located in or on a particular storage modality (e.g., a purse, safe, drawer, vault, etc.). In other words, this exemplary ViSOR app is configured to provide automated (i.e., computer-based) identification or pinpointing of the locations of various storage components, identification or pinpointing of the locations of any specific objects, or categories of objects (e.g., locations of multiple sets of earrings, tools, ties, etc.), stored on or within any storage component.

A wide range of additional applications and features of various ViSOR apps are enabled by the functionality described herein.

### 3.0 OPERATIONAL SUMMARY OF THE VISOR SYSTEM

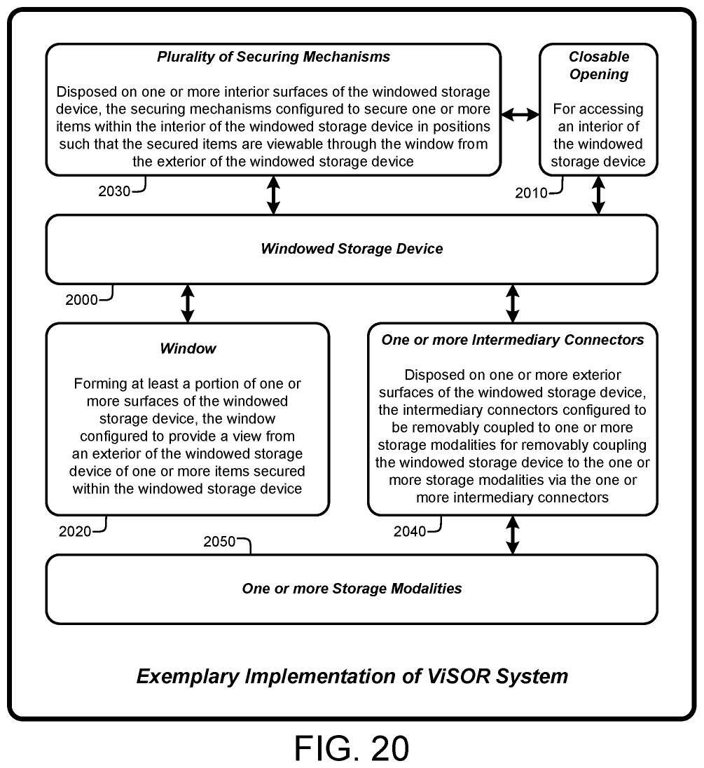

The processes described above with respect to FIG. 1 through FIG. 19, and in further view of the detailed description provided above in Sections 1 and 2, are illustrated by the general operational flow diagrams of FIG. 20 through FIG. 22. In particular, FIG. 20 through FIG. 22 provide exemplary operational flow diagrams that summarize the operation of some of the various implementations of the ViSOR system. FIG. 20 through FIG. 22 are not intended to provide an exhaustive representation of all of the various implementations of the ViSOR system described herein, and the implementations represented in these figures are provided only for purposes of explanation.

Further, any boxes and interconnections between boxes that may be represented by broken or dashed lines in FIG. 20 through FIG. 22 represent optional or alternate implementations of the ViSOR system described herein, and that any or all of these optional or alternate implementations, as described below, may be used in combination with other alternate implementations that are described throughout this document.

In general, as illustrated by FIG. 20, in various implementations, the ViSOR system includes a windowed storage device 2000. In this exemplary implementation, the windowed storage device 2000 also includes a closable opening 2010 for accessing an interior of the windowed storage device. As described throughout this document, the windowed storage device 2000 also includes a window 2020 that forms at least a portion of one or more surfaces of the windowed storage device. Advantageously, this window 2020 is configured to provide a view from an exterior of the windowed storage device 2000 of one or more items secured within the windowed storage device. In addition, a plurality of securing mechanisms 2030 are disposed on one or more interior surfaces of the windowed storage device 2000. Advantageously, these securing mechanisms 2030 are configured to secure one or more items within the interior of the windowed storage device in positions such that those items are viewable through the window from the exterior of the windowed storage device. Finally, in this exemplary implementation, one or more intermediary connectors 2040 are disposed on one or more exterior surfaces of the windowed storage device 2000. Advantageously, these intermediary connectors 2040 are configured to be removably coupled to one or more storage modalities 2050 for removably coupling the windowed storage device 2000 to the one or more storage modalities via the one or more intermediary connectors 2040.

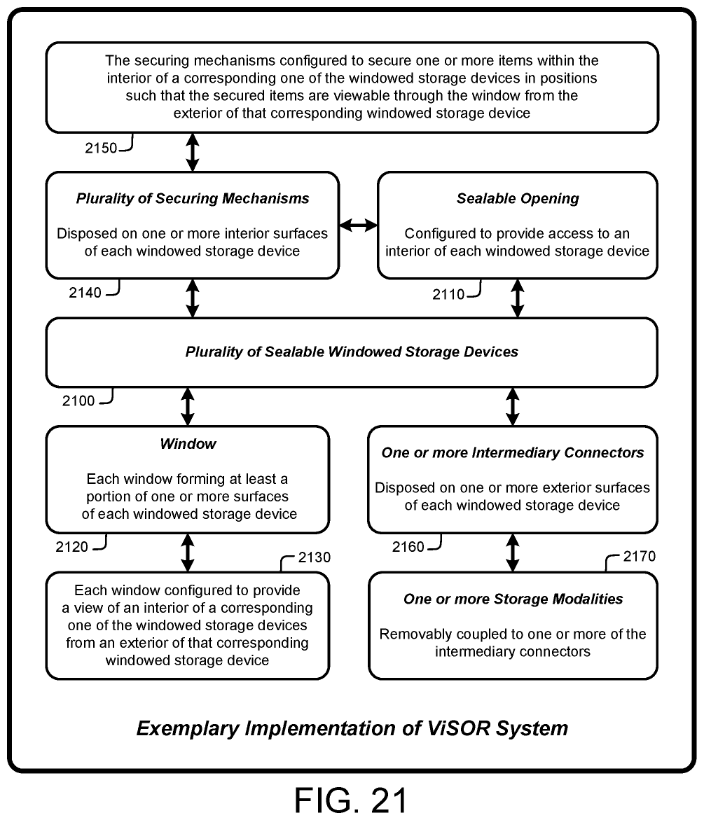

Similarly, as illustrated by FIG. 21, in various implementations, the ViSOR system comprises a plurality of sealable windowed storage devices 2100, with each windowed storage device being configured to provide access to an interior of that windowed storage device via a sealable opening 2110. Further, each of these windowed storage devices 2100 further comprises a window 2120 forming at least a portion of one or more surfaces of each windowed storage device. Advantageously, each window 2120 is configured to provide a view of an interior of a corresponding one of the windowed storage devices 2100 from an exterior of that corresponding windowed storage device. In addition, each windowed storage device 2100 further comprises a plurality of securing mechanisms 2140 disposed on one or more interior surfaces of each windowed storage device. Advantageously, these securing mechanisms 2140 are configured to secure one or more items within the interior of a corresponding one of the windowed storage devices 2100 in positions such that the secured items are viewable through the window 2120 from the exterior of that corresponding windowed storage device. Additionally, one or more intermediary connectors 2160 are disposed on one or more exterior surfaces of each windowed storage device 2100. Finally, in this exemplary implementation, one or more storage modalities 2170 are removably coupled to one or more of the intermediary connectors 2160, thereby removably coupling the corresponding windowed storage devices 2100 to those storage modalities via the corresponding intermediary connectors.

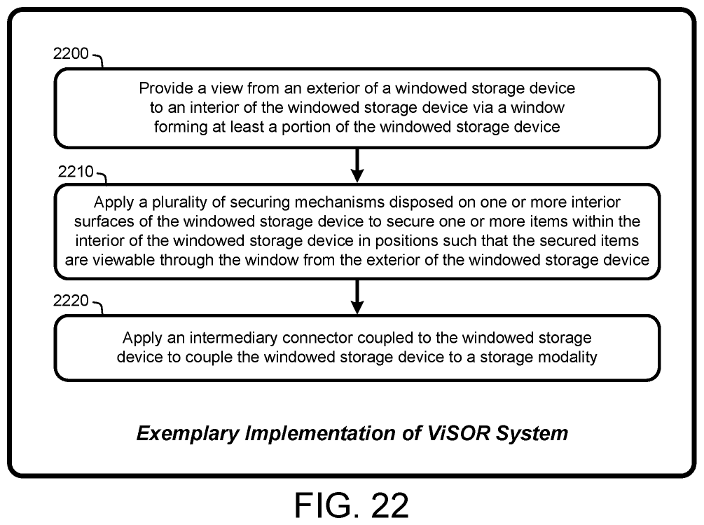

Similarly, as illustrated by FIG. 22 in additional implementations, various components of ViSOR system enable a method that provides 2200 a view from an exterior of a windowed storage device to an interior of the windowed storage device via a window forming at least a portion of the windowed storage device. Further, this method applies 2210 a plurality of securing mechanisms disposed on one or more interior surfaces of the windowed storage device to secure one or more items within the interior of the windowed storage device. Advantageously, these items are secured in positions such that the secured items are viewable through the window from the exterior of the windowed storage device. Finally, in this exemplary implementation, the method continues by applying 2220 an intermediary connector coupled to the windowed storage device to couple the windowed storage device to a storage modality.

### 4.0 EXEMPLARY OPERATING ENVIRONMENTS

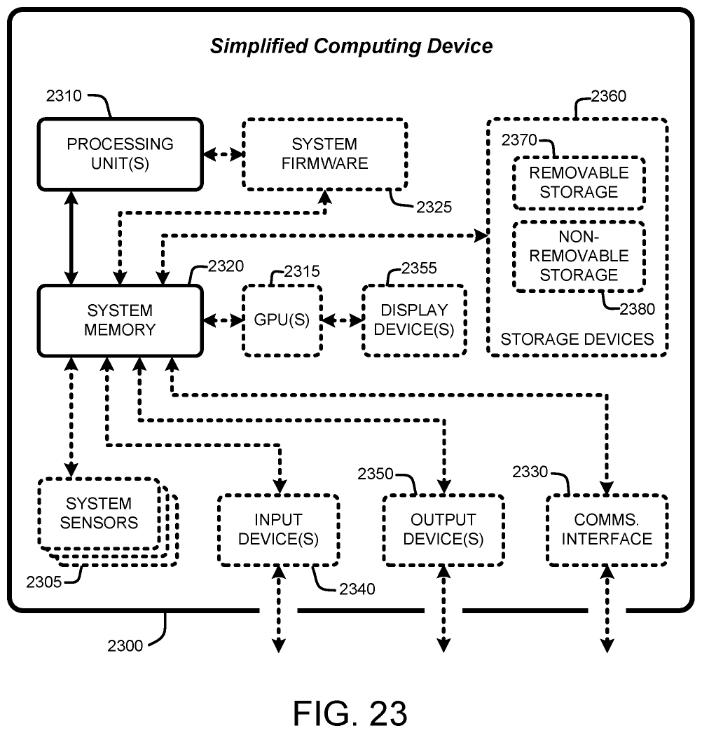

The ViSOR system implementations described herein are operational within numerous types of general purpose or special purpose computing system environments or configurations. FIG. 23 illustrates a simplified example of a general-purpose computer system on which various implementations and elements of the ViSOR system (e.g., some or all of the aforementioned, as described herein, may be implemented. Any boxes that are represented by broken or dashed lines in the simplified computing device 2300 shown in FIG. 23 represent alternate implementations of the simplified computing device. As described below, any or all of these alternate implementations may be used in combination with other alternate implementations that are described throughout this document.

The simplified computing device 2300 is typically found in devices having at least some minimum computational capability such as personal computers (PCs), server computers, handheld computing devices, laptop or mobile computers, communications devices such as cell phones and personal digital assistants (PDAs), multiprocessor systems, microprocessor-based systems, set top boxes, programmable consumer electronics, network PCs, minicomputers, mainframe computers, and audio or video media players.

To allow a device to realize the ViSOR system implementations described herein, the device should have a sufficient computational capability and system memory to enable basic computational operations. In particular, the computational capability of the simplified computing device 2300 shown in FIG. 23 is generally illustrated by one or more processing unit(s) 2310 in communication with system memory 2320. This simplified computing device 2300 may also include one or more graphics processing units (GPUs) 2315 in communication with system memory 2320 and one or more display devices 2355. The processing unit(s) 2310 of the simplified computing device 2300 may be specialized microprocessors (such as a digital signal processor (DSP), a very long instruction word (VLIW) processor, a field-programmable gate array (FPGA), or other micro-controller) or can be conventional central processing units (CPUs) having one or more processing cores and that may also include one or more GPU-based cores or other specific-purpose cores in a multi-core processor.

In addition, the simplified computing device 2300 may also include other components, such as, for example, a communications interface 2330. The simplified computing device 2300 may also include one or more conventional computer input devices 2340 (e.g., touchscreens, touch-sensitive surfaces, pointing devices, keyboards, audio input devices, voice or speech-based input and control devices, video input devices, haptic input devices, devices for receiving wired or wireless data transmissions, and the like) or any combination of such devices.

Similarly, various interactions with the simplified computing device 2300 and with any other component or feature of the ViSOR system, including input, output, control, feedback, and response to one or more users or other devices or systems associated with the ViSOR system, are enabled by a variety of Natural User Interface (NUI) scenarios. The NUI techniques and scenarios enabled by the ViSOR system include, but are not limited to, interface technologies that allow one or more users user to interact with the ViSOR system in a “natural” manner, free from artificial constraints imposed by input devices such as mice, keyboards, remote controls, and the like.

Such NUI implementations are enabled by the use of various techniques including, but not limited to, using NUI information derived from user speech or vocalizations captured via microphones or other input devices 2340 or system sensors 2305. Such NUI implementations are also enabled by the use of various techniques including, but not limited to, information derived from system sensors 2305 or other input devices 2340 from a user's facial expressions and from the positions, motions, or orientations of a user's hands, fingers, wrists, arms, legs, body, head, eyes, and the like, where such information may be captured using various types of 2D or depth imaging devices such as stereoscopic or time-of-flight camera systems, infrared camera systems, RGB (red, green and blue) camera systems, and the like, or any combination of such devices.

Further examples of such NUI implementations include, but are not limited to, NUI information derived from touch and stylus recognition, gesture recognition (both onscreen and adjacent to the screen or display surface), air or contact-based gestures, user touch (on various surfaces, objects or other users), hover-based inputs or actions, and the like. Such NUI implementations may also include, but are not limited to, the use of various predictive machine intelligence processes that evaluate current or past user behaviors, inputs, actions, etc., either alone or in combination with other NUI information, to predict information such as user intentions, desires, and/or goals. Regardless of the type or source of the NUI-based information, such information may then be used to initiate, terminate, or otherwise control or interact with one or more inputs, outputs, actions, or functional features of the ViSOR system.

However, the aforementioned exemplary NUI scenarios may be further augmented by combining the use of artificial constraints or additional signals with any combination of NUI inputs. Such artificial constraints or additional signals may be imposed or generated by input devices 2340 such as mice, keyboards, and remote controls, or by a variety of remote or user worn devices such as accelerometers, electromyography (EMG) sensors for receiving myoelectric signals representative of electrical signals generated by user's muscles, heart-rate monitors, galvanic skin conduction sensors for measuring user perspiration, wearable or remote biosensors for measuring or otherwise sensing user brain activity or electric fields, wearable or remote biosensors for measuring user body temperature changes or differentials, and the like. Any such information derived from these types of artificial constraints or additional signals may be combined with any one or more NUI inputs to initiate, terminate, or otherwise control or interact with one or more inputs, outputs, actions, or functional features of the ViSOR system.

The simplified computing device 2300 may also include other optional components such as one or more conventional computer output devices 2350 (e.g., display device(s) 2355, audio output devices, video output devices, devices for transmitting wired or wireless data transmissions, and the like). Typical communications interfaces 2330, input devices 2340, output devices 2350, and storage devices 2360 for general-purpose computers are well known to those skilled in the art and will not be described in detail herein.

The simplified computing device 2300 shown in FIG. 23 may also include a variety of computer-readable media. Computer-readable media can be any available media that can be accessed by the computing device 2300 via storage devices 2360, and include both volatile and nonvolatile media that is either removable 2370 and/or non-removable 2380, for storage of information such as computer-readable or computer-executable instructions, data structures, programs, subprograms, program modules, or other data.

Computer-readable media includes computer storage media and communication media. Computer storage media refers to tangible computer-readable or machine-readable media or storage devices such as digital versatile disks (DVDs), Blu-ray discs (BD), compact discs (CDs), floppy disks, tape drives, hard drives, optical drives, solid state memory devices, random access memory (RAM), read-only memory (ROM), electrically erasable programmable read-only memory (EEPROM), CD-ROM or other optical disk storage, smart cards, flash memory (e.g., card, stick, and key drive), magnetic cassettes, magnetic tapes, magnetic disk storage, magnetic strips, or other magnetic storage devices. Further, a propagated signal is not included within the scope of computer-readable storage media.

Retention of information such as computer-readable or computer-executable instructions, data structures, programs, subprograms, can also be accomplished by using any of a variety of the aforementioned communication media (as opposed to computer storage media) to encode one or more modulated data signals or carrier waves, or other transport mechanisms or communications protocols, and can include any wired or wireless information delivery mechanism. The terms “modulated data signal” or “carrier wave” generally refer to a signal that has one or more of its characteristics set or changed in such a manner as to encode information in the signal. For example, communication media can include wired media such as a wired network or direct-wired connection carrying one or more modulated data signals, and wireless media such as acoustic, radio frequency (RF), infrared, laser, and other wireless media for transmitting and/or receiving one or more modulated data signals or carrier waves.

Furthermore, software, programs, and/or computer program products embodying some or all of the various ViSOR system implementations described herein, or portions thereof, may be stored, received, transmitted, or read from any desired combination of computer-readable or machine-readable media or storage devices and communication media in the form of computer-executable instructions or other data structures. Additionally, the claimed subject matter may be implemented as a method, apparatus, or article of manufacture using standard programming and/or engineering techniques to produce software, firmware 2325, hardware, or any combination thereof to control a computer to implement the disclosed subject matter. The term “article of manufacture” as used herein is intended to encompass a computer program accessible from any computer-readable device, or media.

The ViSOR system implementations described herein may be further described in the general context of computer-executable instructions, such as instructions, data structures, programs, subprograms, etc., being executed by a computing device. Generally, such computer-executable instructions include routines, programs, objects, components, data structures, and the like, that perform particular tasks or implement particular abstract data types. Various ViSOR system implementations described herein may also be practiced in distributed computing environments where tasks are performed by one or more remote processing devices, or within a cloud of one or more devices, that are linked through one or more communications networks. In a distributed computing environment, computer-executable instructions may be located in either or both local and remote computer storage media including media storage devices. Additionally, the aforementioned instructions may be implemented, in part or in whole, as hardware logic circuits, which may or may not include a processor.

Alternatively, or in addition, the functionality described herein can be performed, at least in part, by one or more hardware logic components. For example, and without limitation, illustrative types of hardware logic components that can be used include field-programmable gate arrays (FPGAs), application-specific integrated circuits (ASICs), application-specific standard products (ASSPs), system-on-a-chip systems (SOCs), complex programmable logic devices (CPLDs), and so on.

### 5.0 OTHER IMPLEMENTATIONS

The foregoing description of the ViSOR system has been presented for the purposes of illustration and description. It is not intended to be exhaustive or to limit the claimed subject matter to the precise form disclosed. Many modifications and variations are possible in light of the above teaching. Further, any or all of the aforementioned alternate implementations may be used in any combination desired to form additional hybrid implementations of the ViSOR system. It is intended that the scope of the ViSOR system be limited not by this detailed description, but rather by the claims appended hereto. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other equivalent features and acts are intended to be within the scope of the claims.

What has been described above includes example implementations. It is, of course, not possible to describe every conceivable combination of components or methodologies for purposes of describing the claimed subject matter, but one of ordinary skill in the art may recognize that many further combinations and permutations are possible. Accordingly, the claimed subject matter is intended to embrace all such alterations, modifications, and variations that fall within the spirit and scope of detailed description of the ViSOR system described above.

In regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the foregoing implementations include a system as well as a computer-readable storage media having computer-executable instructions for performing the acts and/or events of the various methods of the claimed subject matter.

There are multiple ways of realizing the foregoing implementations (such as an appropriate application programming interface (API), tool kit, driver code, operating system, control, standalone or downloadable software object, or the like), which enable applications and services to use the implementations described herein. The claimed subject matter contemplates this use from the standpoint of an API (or other software object), as well as from the standpoint of a software or hardware object that operates according to the implementations set forth herein. Thus, various implementations described herein may have aspects that are wholly in hardware, or partly in hardware and partly in software, or wholly in software.

The aforementioned systems have been described with respect to interaction between several components. It will be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (e.g., hierarchical components).

Additionally, one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known to enable such interactions.

What is claimed is:

1. A modular storage system, comprising:
a windowed storage device, comprising:
a closable opening for accessing an interior of the windowed storage device,
a window forming at least a portion of one or more surfaces of the windowed storage device, the window configured to provide a view from an exterior of the windowed storage device of one or more items secured within the windowed storage device, and
a plurality of securing mechanisms disposed on one or more interior surfaces of the windowed storage device, the securing mechanisms configured to secure one or more items within the interior of the windowed storage device in positions such that the secured items are viewable through the window from the exterior of the windowed storage device;
one or more intermediary connectors disposed on one or more exterior surfaces of the windowed storage device, the intermediary connectors configured to be removably coupled to one or more storage modalities for removably coupling the windowed storage device to the one or more storage modalities via the one or more intermediary connectors.

2. The modular storage system of claim 1 wherein one or more of the intermediary connectors disposed on one or more exterior surfaces of the windowed storage device are removably coupled the windowed storage device.

3. The modular storage system of claim 1 wherein one or more of the intermediary connectors are configured to be removably coupled to one or more other intermediary connectors that are in turn configured to be removably coupled to the one or more storage modalities.

4. The modular storage system of claim 1 further comprising one or more locking mechanisms for securing removable couplings between any combination of:
one or more intermediary connectors and the windowed storage device;
two or more intermediary connectors, and
one or more intermediary connectors and one or more storage modalities.

5. The modular storage system of claim 4 further comprising a computing device in communication with one or more of the locking mechanisms, the local computing device adapted to perform any of automatically locking and unlocking one or more of the locking mechanisms in response to user input received by the computing device.

6. The modular storage system of claim 5 wherein the user input received by the computing device further comprises sensor-derived biometric information relating to the user.

7. The modular storage system of claim 1 further comprising a computing device in communication with one or more sensor devices, each of the sensor devices configured to obtain and transmit sensor data to the computing device, the sensor data relating to any of the windowed storage device, the one or more intermediary connectors, the one or more storage modalities, and biometric information relating to one or more persons.

8. The modular storage system of claim 7 wherein the computing device applies sensor data received from one or more sensor devices to generate an inventory report relating to one or more items secured within any of a plurality of the windowed storage devices.

9. The modular storage system of claim 7 wherein the computing device applies sensor data received from one or more sensor devices to generate an access report relating to any of the windowed storage device, the one or more intermediary connectors, and the one or more storage modalities.

10. A system, comprising:
a plurality of sealable windowed storage devices, each windowed storage device configured to provide access to an interior of that windowed storage device via a sealable opening;
each windowed storage device further comprising a window forming at least a portion of one or more surfaces of each windowed storage device;
each window configured to provide a view of an interior of a corresponding one of the windowed storage devices from an exterior of that corresponding windowed storage device;
each windowed storage device further comprising a plurality of securing mechanisms disposed on one or more interior surfaces of each windowed storage device;
the securing mechanisms configured to secure one or more items within the interior of a corresponding one of the windowed storage devices in positions such that the secured items are viewable through the window from the exterior of that corresponding windowed storage device;
one or more intermediary connectors disposed on one or more exterior surfaces of each windowed storage device; and
one or more storage modalities removably coupled to one or more of the intermediary connectors.

11. The system of claim 10, further comprising a plurality of sensor devices configured to transmit sensor data to one or more computing devices, the sensor data relating to any of the windowed storage devices, the intermediary connectors, and the storage modalities.

12. The system of claim 11, wherein the one or more computing devices apply sensor data received from one or more of the sensor devices to generate an inventory report relating to one or more items secured within any of a plurality of the windowed storage devices.

13. The system of claim 11, wherein the one or more computing devices apply sensor data received from one or more of the sensor devices to generate an access report relating to any of the windowed storage devices, the intermediary connectors, and the storage modalities.

14. The system of claim 10, further comprising one or more locking mechanisms for securing removable couplings between any combination of:
one or more intermediary connectors and one or more windowed storage devices;
two or more intermediary connectors, and
one or more intermediary connectors and one or more storage modalities.

15. The system of claim 14, wherein one or more of the locking mechanisms are electromechanical locking mechanisms in communication with one or more computing devices, the computing devices configured to automatically lock and unlock one or more of the locking mechanisms in response to user input received by one or more of the computing devices.

15. The system of claim 14, wherein the user input received by one or more of the computing devices further comprises sensor-derived biometric information relating to the user.

16. A method, comprising:
providing a view from an exterior of a windowed storage device to an interior of the windowed storage device via a window forming at least a portion of the windowed storage device;
applying a plurality of securing mechanisms disposed on one or more interior surfaces of the windowed storage device to secure one or more items within the interior of the windowed storage device in positions such that the secured items are viewable through the window from the exterior of the windowed storage device; and
applying an intermediary connector coupled to the windowed storage device to couple the windowed storage device to a storage modality.

17. The method of claim 17, further comprising, applying a plurality of sensor devices to transmit sensor data to one or more computing devices, the sensor data relating to any of the windowed storage devices, the intermediary connectors, and the storage modalities.

18. The method of claim 17, further comprising, responsive to the sensor data, applying one or more of the computing devices to generate an inventory report relating to one or more items secured within the windowed storage device.

19. The method of claim 17, further comprising, responsive to the sensor data, applying one or more of the computing devices to generate an access report relating to any of the windowed storage device, the intermediary connector, and the storage modality.

20. The method of claim 17, further comprising, responsive to the sensor data, applying one or more of the computing devices to generate a report relating to environmental conditions in the vicinity of any of the windowed storage device, the intermediary connector, and the storage modality.
